(19) United States
(12) Patent Application Publication
(10) Pub. No.: US 2003/0197625 A1
(43) Pub. Date: Oct. 23, 2003

(54) INFRARED CONTROLLERS INTEGRATED WITH INCANDESCENT AND HALOGEN LAMP POWER DRIVERS

(76) Inventor: STEFAN F. SZUBA, ANN ARBOR, MI (US)

Correspondence Address: JAMES M DEIMEN, SUITE 300, 320 N MAIN STREET, ANN ARBOR, MI, 481041192

(21) Appl. No.: 09/371,106

(22) Filed: Aug. 10, 1999

Related U.S. Application Data
(60) Provisional application No. 60/095,933, filed on Aug. 10, 1998.

(51) Int. Cl. G08C 19/00

(52) U.S. Cl. 340/825.69

(57) ABSTRACT

A new lighting control utilizes common infrared remote controllers such as the “universal remote controller” available for controlling TV, VCR and other audio/video components and devices in home use. The new infrared receiver controllers incorporate receivers that recognize many control protocols, have the ability to learn and respond to one protocol field-assigned to a particular control device and to simultaneously ignore messages directed to other control system components. A particular receiver is able to accept different communication protocols generated under audio/video maker-specific presets. Most audio/video makers have a proprietary code format which differs from others in carrier frequency used, code type (bi-phase or pulse distance modulation), length of message, timing of data bits and start sequence, repetition format and rate and number of bits/message. The receiver and associated microprocessor recognizes a particular characteristic of an incoming communication and by comparison with a plurality of images in memory locks on to a particular code and screens out other codes stored in memory which may be used for other devices and components controlled by the infrared remote controller. In this manner, a particular light or plurality of lights may be controlled by the same “universal remote controller” that controls the TV, VCR and other devices in the same room or vicinity.

### BACKGROUND OF THE INVENTION

This application is based on provisional patent application Serial No. 60/095,933 filed Aug. 10, 1998.

The field of the invention pertains to artificial lighting systems of controllable intensity and, in particular, to applications of such lighting in small areas at low cost. Controllable lighting in homes and small office suites is either of limited capability such as wall mounted rheostats for incandescent lights or very expensive systems adapted from large commercial installations.

An example of a system for controlling a plurality of ceiling mounted fluorescent lamps is disclosed in applicant's previous U.S. Pat. No. 5,381,078 wherein a wall-mounted electronic potentiometer system is provided for controlling fluorescent lamps by way of ceiling mounted controllers. A two wire communications bus connects a plurality of electronic potentiometers with the ceiling mounted controllers in a network to enable the light intensity in any location to be controlled from any of the wall mounted potentiometers.

Another example of a controllable lighting system for large commercial installations is applicant's U.S. Pat. No. 5,220,250 directed to a fluorescent lamp lighting arrangement controlled by both a motion detector and a light sensing detector operable when motion is detected by the motion sensor. The lighting device dims the lights when no activity is sensed in the lighted area. The amount of artificial light provided to an area is varied in accordance with the amount of natural light striking the area.

Small area lighting controls are also known, and some of them use wireless electrical power control of the power supplied to the load. In some executions, infrared remote control transmitters are employed. See, for example, U.S. Pat. No. 5,506,716 issued Apr. 9, 1996 to J. S. Zhu, U.S. Pat. No. 5,382,947 issued Jan. 17, 1995 to M. Thaler et al., and U.S. Pat. No. 5,099,193 issued Mar. 24, 1992 to R. Moseley et al.

U.S. Pat. No. 5,506,716 discloses a lighting system for controlling a fluorescent fixture using a commercially available infrared remote controller and a receiver. The patent describes a decoder with a software filter operating on demodulated signal of a given format, so that the control system may reliably function in the presence of infrared interference having frequencies at and about the carrier frequency of the transmitted signal. This idea is targeted towards controlling fluorescent fixtures operated by high frequency electronic ballasts. The majority of electronic ballasts for the industrial market segment, such as energy efficient buildings, operate in the frequency range 20 to 40 kHz, which is about the same as the carrier frequency band employed in remote controllers for audio/video markets. Interference produced by fluorescent lamps operated in the above frequency range severely disturbs communications transmitted by audio/video remotes. To help the situation, major makers of electronic ballasts are now moving ballast operating frequencies out of the remote control band. For example, 42 kHz may be employed as the ballast operating frequency. Some Philips ballasts operate now at this particular frequency and are marketed as “non-interfering with remote controllers”. The above may suggest a rather low practical importance (cost/performance) of design methodologies such as the one protected by U.S. Pat. No. 5,506,716.

U.S. Pat. No. 5,382,947 focuses on remote-controlled operation of a plurality of electrical consumers by means of a control system. A plurality of control devices can be addressed with an operating device by means of the address coding of messages. The patent states that communication messages contain at least one address field and one data field. Nowhere does the document explain how the addresses are derived or defined, nor does it give any detail of control protocols. FIG. 4 illustrates the use of a separate converter performing the task of receiving and retransmitting messages from the transmitter to control devices. The overall arrangement is a precursor to what is introduced in the last part of applicant's below disclosure as an advanced control and communication platform built around technology available from Echelon Corp.

Finally, U.S. Pat. No. 5,099,193 reveals a system where power supplied to a load may be varied using a remote control device. A dedicated transmitter and receiver system is introduced which operates at a 108 kHz carrier frequency. Some method-specific hardware is also disclosed. There is an overview of system topology shown in FIG. 1. Again, this may be compared with the above mentioned applicant's disclosure of an advanced control and communication platform which, from a system flexibility point of view, among others, outperforms the solution disclosed in this patent.

### SUMMARY OF THE INVENTION

The invention is directed to relatively simple economical to manufacture and easy to install lighting controls. It is an object of the invention to provide a device and system easily operable by a private homeowner or small business owner.

The new lighting control utilizes infrared remote controllers not unlike home audio and television remote controllers in common use. Both hardware intensive and software intensive circuits are disclosed for controlling incandescent and halogen light levels. Light levels of individual lamps or groups of lamps may be controlled. Group configuration may be changed by reprogramming subsequent to the initial hardware installation and software installation. The necessary hardware components to create the circuits are readily available at very low cost in comparison with the lighting fixtures to which they are electrically connected.

Applicant's disclosure focuses on application of remote control concepts in a different way than what is covered by the above discussed patents. A new technology is introduced using standard remote controllers, and, in particular, the new technology is targeted towards what is called a “universal remote controller” that appeared on the market 2-3 years ago. These universal remote controllers can practically control any audio/video product that is or was available on the market. They thus offer a lot of control power that in most cases is not fully utilized by their owners' audio/video devices.

These controllers may be used to control electrical products (lamps, fans, blinds, etc.) other than audio/video products. In most applications, these other electrical products will have to operate next to audio/video products and be, in most cases, under the control of the same physical transmitter unit. They will thus have to respond to control commands of a different format than the audio/video products operating in the same control scenario respond to. Thus, independent functionality of components of the control system must be realized. What this requires is the introduction of a receiver (hardware and software) that recognizes many control protocols, has the ability to learn and respond to one protocol field-assigned to a particular control device and to simultaneously not respond to messages directed to other control system components. The above may be termed as an implementation of address assignment and installation of components control system.

Thus, the receiver according to this application will be able to accept different communication protocols generated under audio/video maker-specific presets by, for example, a universal remote controller. In the present implementation, the receiver can respond to 22 different control codes generated by the remote transmitter. Most of the audio/video makers have a proprietary code format which, in general, differs from others in carrier frequency used, code type (bi-phase vs. pulse distance modulation), length of message, timing of data bits and start sequence, repetition format and rate, and number of bits/message. The receiver, a kind of wide-band AM hardware, accepts different codes. A microprocessor servicing the receiver hardware stores certain code-specific characteristics of each of 22 control codes. Upon reception, a real-time measured characteristic of an incoming communication is compared with the image stored in the microprocessor memory. After the code has been recognized, the receiver remains locked to this particular code and will not respond to others whose images are stored in memory so that other codes may be used to control other control system components.

The above describes not only the particular execution of controls, but also the mechanism for assigning the logical address (implemented on the protocol level rather than address bits of a particular protocol) and installation of components in the simplest control system scenario. One reason that 22 protocols can be recognized by the receiver is to provide enough margin so that additional items can be controlled and not interfere with protocols that may be in use to control a TV, VCR or an audio/video component. The other is size of memory of the microprocessor used in the proposed implementation. To keep cost down, a small 2 k-byte chip is adequate, and it is primarily memory size that defines number of protocols decoded. The method is general in character, and the receiver decoding capability can be enhanced if a more powerful microprocessor is used. Given the market segment this product is intended to address, practically no software overhead is created to cope with infrared in-band interference. What is more, by comparison in the conditions of a multi-code receiver, it looks next to impossible to arrive at an efficient low-cost solution if one wants to implement the kind of strategy disclosed in the J. S. Zhu patent.

The hardware that attaches to the receiver is, of course, specific and dictated by I/O capabilities of the microprocessor employed, here by a type of D to A conversion possible with the given chip. And, of course, this receiver can interface to power drivers of many appliances and will as well interface to a higher level control and communication platform such as the Echelon Corp. product.

### BRIEF DESCRIPTION OF THE DRAWINGS

FIG. 1 illustrates interior lighting with remotely controlled fixtures;

FIG. 2 is an electric circuit for an infrared microprocessor based lighting control;

FIG. 3 illustrates electric signal timing comparisons for FIG. 2;

FIG. 4 is a software flow diagram for FIG. 2;

FIG. 5 is an electric circuit for an infrared controlled incandescent lamp dimmer using a dedicated integrated circuit for triac control;

FIG. 6 is an electric circuit for a software intensive infrared controlled incandescent lamp dimmer;

FIG. 7 illustrates electric signal timing comparisons during infrared communication for FIG. 6;

FIG. 8 is a software flow diagram for FIG. 6;

FIG. 9 is an electric circuit for a halogen lamp power drive with a half-bridge output stage as a lamp power regulator;

FIG. 10 is an electric circuit for a halogen lamp control incorporating communication with variable frequency isolated drive circuitry;

FIG. 11 is an electric circuit for an infrared communication receiving device with a network processor and transformer coupled communication transceiver;

FIG. 12 is a ladder diagram electric circuit for lighting with logical addressing and infrared communication;

FIG. 13 is a software flow diagram for response to an Install Message;

FIG. 14 is a software flow diagram for response to an ID Message;

FIG. 15 is a software flow diagram for response to an Accept Message;

FIG. 16 is a software flow diagram for response to a Dial Message;

FIG. 17 is an alternative electric circuit for an incandescent lamp dimmer;

FIGS. 18a and 18b depict bi-phase modulation and pulse-distance modulation;

FIG. 18c is a software flow diagram for detection and response to the type of modulation; and

FIG. 19 schematically depicts wall box and load modules.

### DESCRIPTION OF THE PREFERRED EMBODIMENTS

The following disclosure describes several embodiments for using standard audio/video infrared remote controllers in lighting applications.

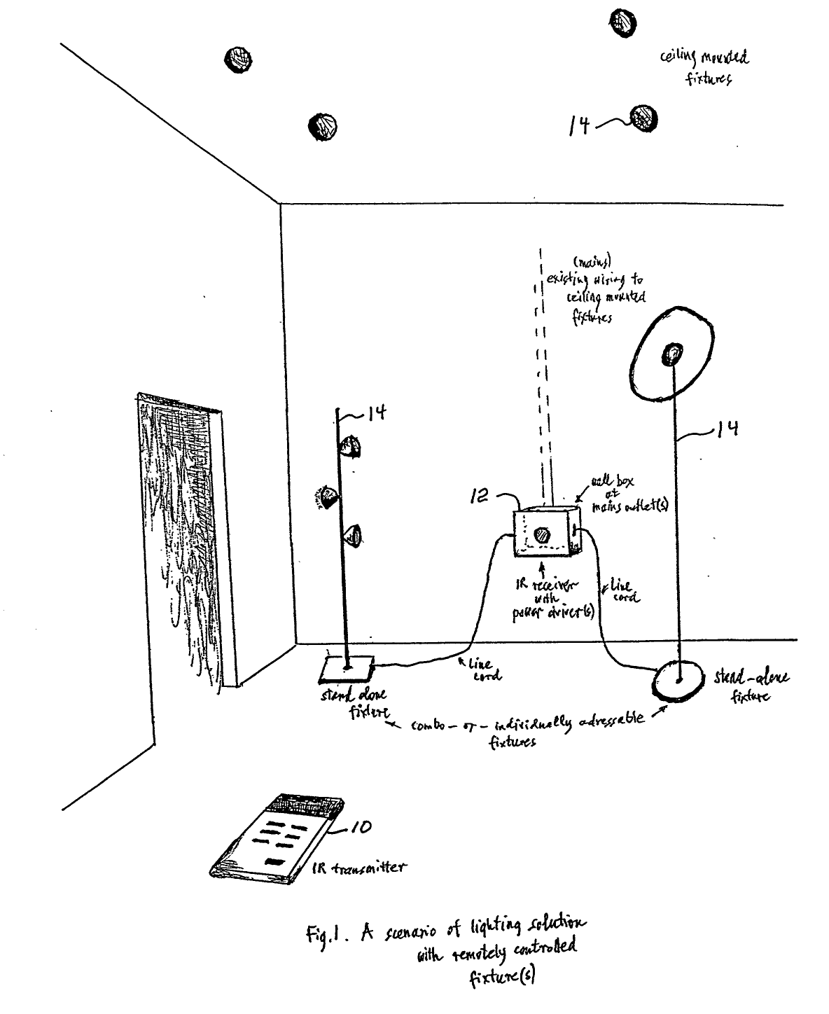

FIG. 1 illustrates a general scenario where a hand-held infrared transmitter 10, such as one known from the audio/video market, executes a communication protocol developed by its manufacturer for audio/video applications (Philips, RCA, Toshiba, etc.) and its messages are received by an appropriate infrared receiver 12, decoded and used to implement lighting 14 control functions.

User-friendliness is an obvious advantage of using such a control method. This technology may be implemented to retrofit or upgrade existing stand alone fixtures and lighting installations, and be applied to create lighting applications with various degrees of functional and structural flexibilities such as elimination of vertical wiring.

The scope of the application of infrared controls is directed down to residential and small business market segments where incandescent and halogen light sources are in the most common use.

What follows is a detailed description of hardware and software solutions for a few lighting applications which may be of broadest interest.

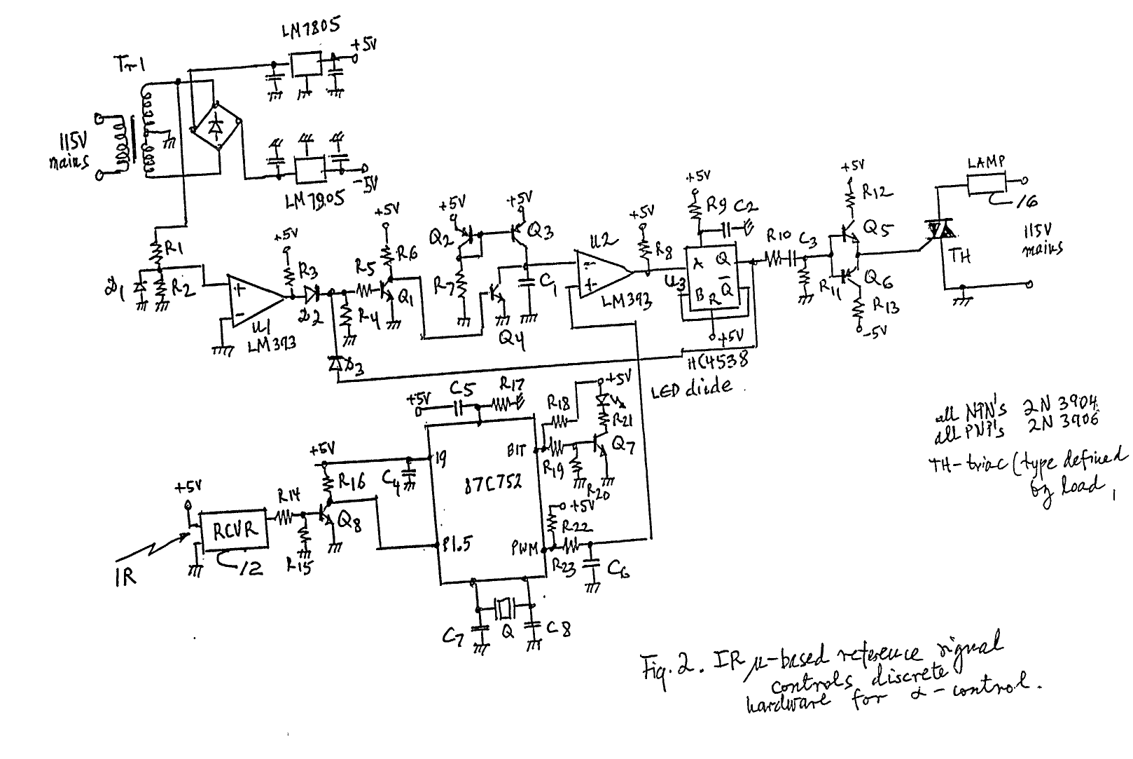

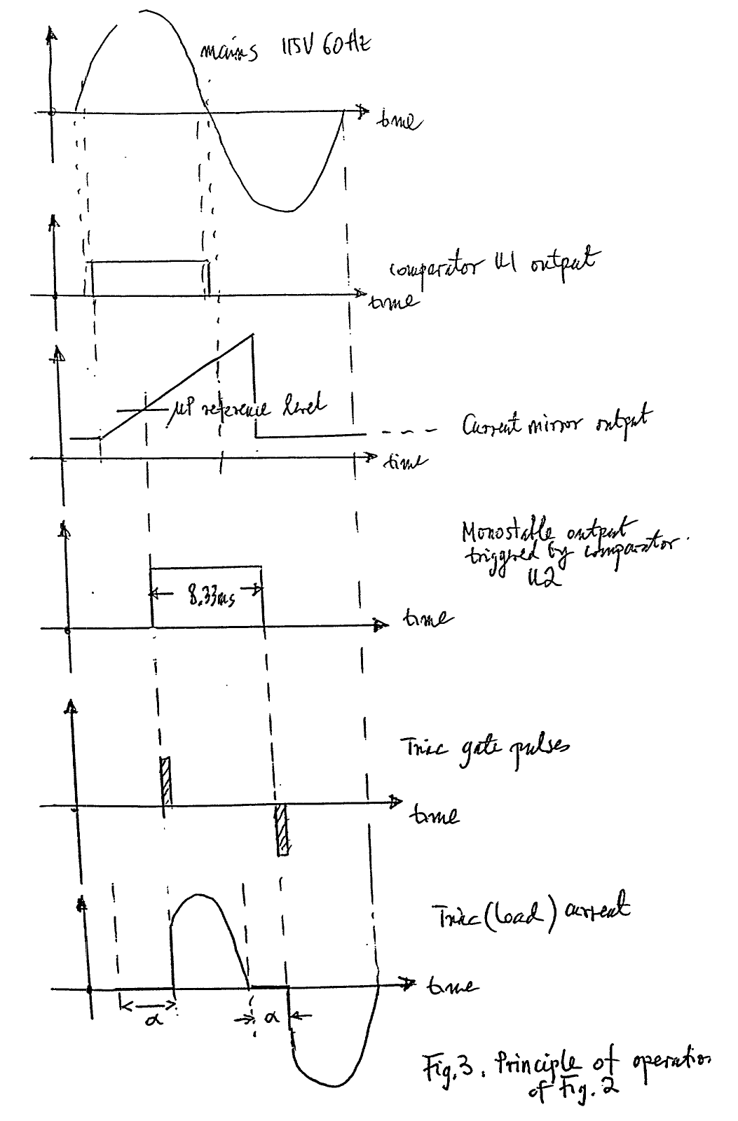

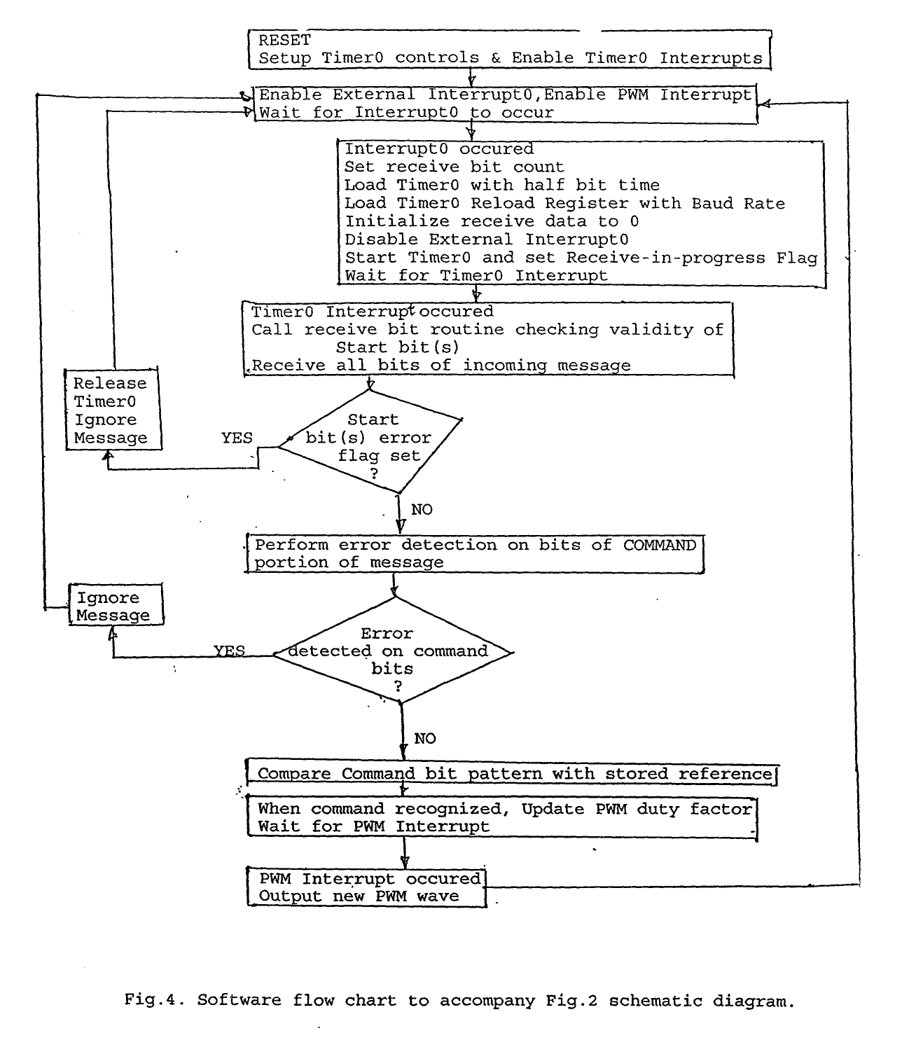

FIG. 2 illustrates a schematic diagram of an infrared controlled power driver operating an incandescent lamp 16 or any practical number of lamps. There is no limitation on the power rating of the installation, as there is no requirement to use a particular control protocol. For simplicity and brevity, one light source is shown, whereas software and hardware execution are illustrated using Philips RC-5 code as an example. The data related to software routines are in this example code specific.

Circuitry depicted in FIG. 2 may be implemented in a form of a plug-and-play box where the mains outlet and lighting fixture will be terminated. The box could be plugged into the mains outlet, for example. The infrared receiver 12 would be preferably located on an outward facing surface. An optional LED could also be used with this circuitry to signal incoming infrared communication.

The term a-control will be used through out this description to stand for phase delay control of a three terminal ac semiconductor switch known as a triac.

The voltage produced across the secondary winding of an auxiliary power supply step down transformer TRI is sampled by voltage divider R1 and R2 so that zerocrossings of positive halves of the ac line may be further detected and processed by comparator U1, whose output is the ac mains synced waveform as shown in FIG. 3. The output of the comparator is processed by a wired-OR gate, built of diodes D2 and D3, and inverted by transistor switch Q1. The output of inverter Q1 controls the turn on and off of discharge transistor Q4 whose output provides a path of discharge current for capacitor C1. Capacitor C1 together with resistor R7 and current mirror Q2-Q3 form a sawtooth waveform oscillator whose full cycle may be as long as the ac line period. The oscillator cycle is initialized by comparator U1 and inverter Q1 whose output disables transistor Q4. The voltage across capacitor C1 is further compared with dc reference voltage applied to the positive input of comparator U2, see FIGS. 2 and 3. When sawtooth voltage exceeds dc reference voltage, comparator output undergoes a low-to-high transition which in turn provides a trigger for monostable multivibrator U3. U3 produces a 8.33 ms long pulse which is fed back to operate discharge transistor Q4 via wired-OR gate D2-D3. When U3 pulse ends, transistor Q4 turns on and discharges capacitor C1. Q4 will stay on until the next ac line cycle. The output 8.33 ms pulse produced by U3 is also fed forward to excite differentiating network built of R10 and C3. The output of this network is a train of 200 usec long pulses, see FIG. 3, whose current is amplified by transistor pair Q5 and Q6 and drives the gate of triac TH at twice the mains rate. The triac conduction angle is thus controlled by the dc reference voltage applied to comparator U2 and the resulting load (lamp) current waveform, shown in FIG. 3, produces lamp power of desired level.

It can be seen from the above explanation and waveforms shown in FIG. 3 that dc reference voltage at comparator U2 represents desired lamp power. This voltage is produced by a microprocessor as a response to control messages transmitted via an infrared communication link.

An infrared receiver 12, RCVR, may be implemented using a dedicated IC, such as a TDA 3047 infrared receiver to work with the Philips developed RC-5 code, for example. The output pulse train at the receiver output is then inverted by switch Q8 and presented to an interrupt pin of a microprocessor-based communication decoder. The Intel 87c752 8-bit processor based communication decoder is suitable and its operation with RC-5 code is described in greater detail below.

Hardware inputting of incoming communication is implemented using the highest priority interrupt available in the software repertoire. A quartz clock Q, of, for example a 5 MHz rate, provides timing for instruction execution. One of the output pins drives switch Q7 and LED which blinks at the rate of incoming control messages to provide the user with confirmation of system operation. A dedicated Pulse Width Modulated output available with the 87C 752 processor is programmed at a fixed frequency and variable duty factor. Variations in the duty factor are a form of analog coding of digital control messages. This waveform runs at a frequency of 10 kHz, for example, is further dc filtered by R23 and C6 filter, whose output is a dc reference voltage and whose amplitude is a function of the earlier mentioned duty factor. The dc reference voltage is then applied to comparator U2 and defines the power level delivered to the lamp(s) load.

The software flow chart is illustrated in FIG. 4. The approach used to develop decoding routines is general and may be customized to many communication protocols. Here, Philips RC-5 code is taken on for illustration. Before going into the details of the application software, RC-5 protocol will be briefly introduced.

This protocol, like others of its kind, is subject to standardization—message format, command code allocation, addressing, etc. are fixed and may not be changed.

An RC-5 code word consists of 14—bits: startbit, fieldbit, controlbit, 5 systembits and 6 commandbits. The code is of a bi-phase type where bit values are determined by the pulse edge in the middle of the bit cell. The time of the bit cell is 1.778 ms. A code word of 14 bits lasts 24.889 ms. Code word repetition time is 113.778 ms. Startbit is the first bit in the code word, it is always logic 1. Since decoders introduced in this disclosure are dedicated to lighting application, only 6 command bits are decoded. In 6 bits 64 different commands may be coded. For simple lighting applications only a few are needed, namely: power on, power off, dim up and down, a number of preprogrammed presets for specific task light levels, and a programming key.

FIG. 4 illustrates the decoder software flow chart. The microprocessor employed to execute the decoder software is 83C752/87C752 which offers advantages of 80C51 architecture and a powerful instruction set in a small package and at a low cost. It contains a 2K×8 masked ROM/EPROM, 64 bytes of RAM, 21 I/O lines, a 16 bit auto-reload timer/counter, a seven-source fixed priority interrupt architecture and, among others, a PWM (pulse width modulated) output. This microprocessor does not have a hardware Universal Asynchronous Receiver/Transmitter (UART) on-chip. The routines flow-charted in FIG. 4 essentially demonstrate a kind of an UART function implemented with a microprocessor without the benefit of hardware UART. Physical connection to the outside world requires here only one I/O pin which is an external interrupt input pin. This allows the software to be interrupted automatically at the beginning of an incoming message start bit and synchronizes the timer accurately to the serial communication data stream.

The software flow-charted in FIG. 4 will receive 1200 Baud messages, error-check them, implement decoding and output commands via a D/A converter based on DC filtered PWM output provided by the chip. The methodology presented here is illustrated using Philips code as an example; it may be easily modified (Baud rates, message structures and sizes) to accept numerous codes employed by the audio/video market.

After chip reset initialization, 16-bit timer/counter (Timer 0) controls are set up and relevant interrupts enabled. Beginning with a start bit occurring on the serial input line, an interrupt (External Interrupt 0) will occur. At the external interrupt 0 service routine, the Timer 0 is loaded with a value that will result in a time delay that is approximately equal to half a bit cell time of a 1200 Baud data stream (or, in general, for the baud rate being used) less some time to allow for the latency between interrupt and the real-time point of data sampling. Timer reload register is loaded with a value that will result in a time delay that is a close approximation of one bit cell time. The program then will start the timer, return to the main program and wait for the timer to time out generating an interrupt. At that point the message start bit should be about halfway through its nominal duration. When the first interrupt occurs, the Timer 0 interrupt service routine activates another routine which error-checks the incoming bit stream and inputs other bits of incoming message to serial holding registers. If start bits are erratic, reception is discontinued, message ignored and Timer 0 released to reception of next input message. A message whose start bits are valid is input as mentioned earlier to holding registers and before command decoding has been performed, some bit error checking is run. If message is erratic, it will be discarded. If it is valid, its content is compared against stored references and interpreted accordingly. Resulting control action is then presented in the form of a duty factor value from a PWM output pin available as one of I/O modes of the processor used. The new value of duty factor represents a power requirement, i.e. light output, of the lighting arrangement under control. To present and use digital representation of a control action, a D/A conversion is needed. The latter will be implemented in the form of DC filtering of the PWM waveform whose frequency was set equal to 10 kHz. The DC voltage so obtained is further used as a reference voltage operating at one of the comparator U2 inputs (see FIG. 2) and thus the resulting power control of the lighting scheme is a function of microprocessor output reference voltage.

This form of UART implementation and then D/A output presentation is not protocol specific and therefore can be used with commercially available infrared controllers commonly used in audio/video markets provided that actual protocol speeds and data structures are embedded in software routines.

The controller implementation presented above will perform light control in an infinite number of steps.

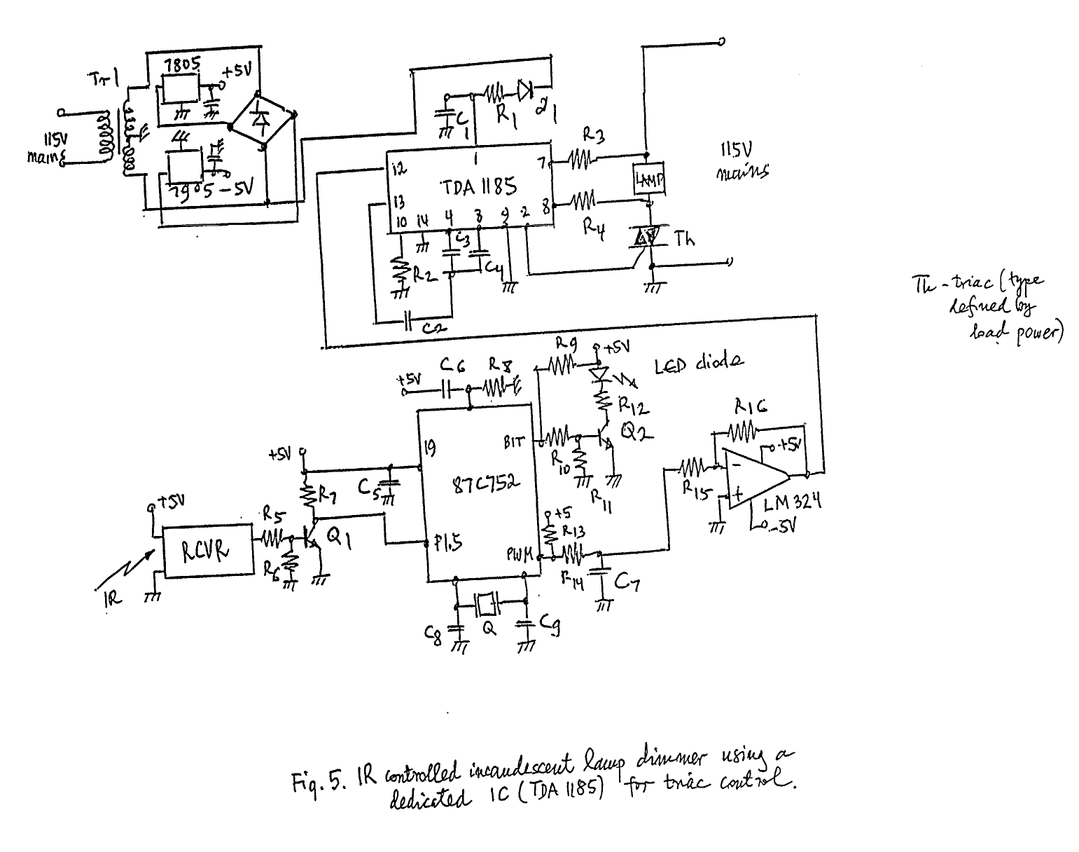

An alternative implementation of the hardware portion of the FIG. 2 circuitry may be built around a monolithic triac phase controller such as the Motorola TDA1185A. This chip generates trigger pulses for triac control (pin 2 in FIG. 5) of power into the ac load. The triac trigger pulse is determined by generating a ramp voltage at pin 4, synchronized to twice the ac line frequency and compared to the external control voltage delivered at pin 12 representing conduction angle. Control voltage is derived from the output of an inverting amplifier, such as LM324, which in turn is driven by a DC filtered PWM signal output from a microprocessor operating as explained above in the introduction to FIG. 2. Feedback loop at pin 9 is disconnected and pin 9 grounded so that microprocessor output is the sole controller of ac power. Soft start feature may be used to limit lamp inrush current and thus protect lamp to some extent.

The FIG. 5 implementation uses a mains isolated ±5V auxiliary power supply for microprocessor and inverting amplifier. Both circuits, FIG. 2 and FIG. 5, make use of a LED diode driven by one of microprocessor I/O lines. The intention of having this diode is, as it was mentioned earlier, to provide the user with some kind of visual effect reflecting operation of an infrared communication channel. The FIG. 5 circuit, similar to the FIG. 2 one, realizes ac power control in an infinite number of steps.

The circuit of FIG. 2 provides an ac power regulation from 98% of the manufacturer's load specified rating to a design defined minimum such as 10%, for example. The circuit of FIG. 4 with a purely resistive load may implement a full range load power control.

Both circuits can control single and multiple light loads of widely varying power ratings. Both can be easily used as a retrofit or refurbishment of existing lighting schemes.

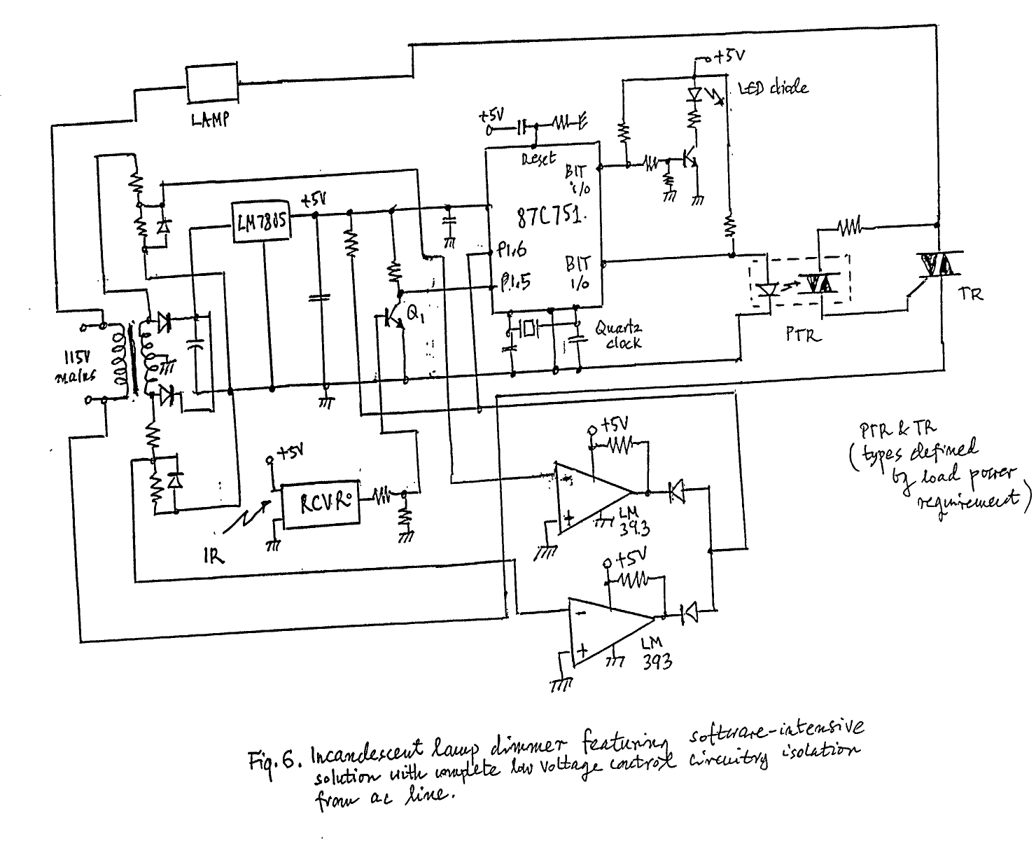

Another alternative execution of light output control is shown in FIG. 6 Here the lamp load is switched from a microprocessor such as the one introduced earlier in this document. It is optically isolated from unexpected line or load behavior. A phototriac PTR is used as a driver for power regulating triac TR. Current flowing by phototriac triggers the main triac which then shorts and turns off the photo-triac. The process repeats itself every half cycle until the driving LED is off. The driving LED is under the control of a microprocessor generated pulse stream. A line zerocrossing detector is implemented using comparators such as LM393, for example. These comparators output signals that are monitored by one of the microprocessor's external interrupt inputs. Software responds to detected interrupts of line zerocrossings as well as interrupts generated in response to infrared communication as it was presented in the other possible executions of the controller. Since I/O capable of generating PWM waveform is no longer needed, the very basic derivative 87C751 of the 8051 family may be employed. Both external interrupt inputs will be used, P1.5 INT0 (external interrupt 0 input) as a receiving pin for infrared communication and P1.6 INT1 (external interrupt 1 input) as a monitor of ac line zerocrossings. Timer 0 will be employed as a timer/counter configured to control the delay of an output signal with respect to either rising edge or a falling edge as a synchronization input. Here, the sync input will be implemented using both rising and falling edges. The output pulse is about 200 us wide synced to the zerocrossings of ac line.

This execution requires software that will allow 87C751 to implement a kind of UART that will send and receive serial data synchronously. To implement flawless transmission and reception of serial data, the new circuit uses a Timer 0 as a data recovery clock and data transmit clock, whose start is synchronized to ac line zerocrossings. For a 1200 Baud data rate, a high speed serial shifter operating at 4 times the bit rate allows the start bit leading edge to be located more accurately than 1× clock would allow. The high speed sampling also allows several samples to be taken within a bit time, so the logic can make an intelligent decision about the logic sense of a bit.

Referring back to the FIG. 6 circuit, serial data are inverted at transistor Q1 and presented to pin 1.5 looking at external interrupt 0 of highest priority. Mains zerocrossings are delivered active low to pin 1.6 looking at external interrupt 1. With sufficient of analog hardware, such as the ones of the FIG. 2 and FIG. 5 circuits, being now replaced by a microprocessor, it is convenient to implement light control in a limited number of discrete steps instead of indefinite-step control possible with earlier circuits.

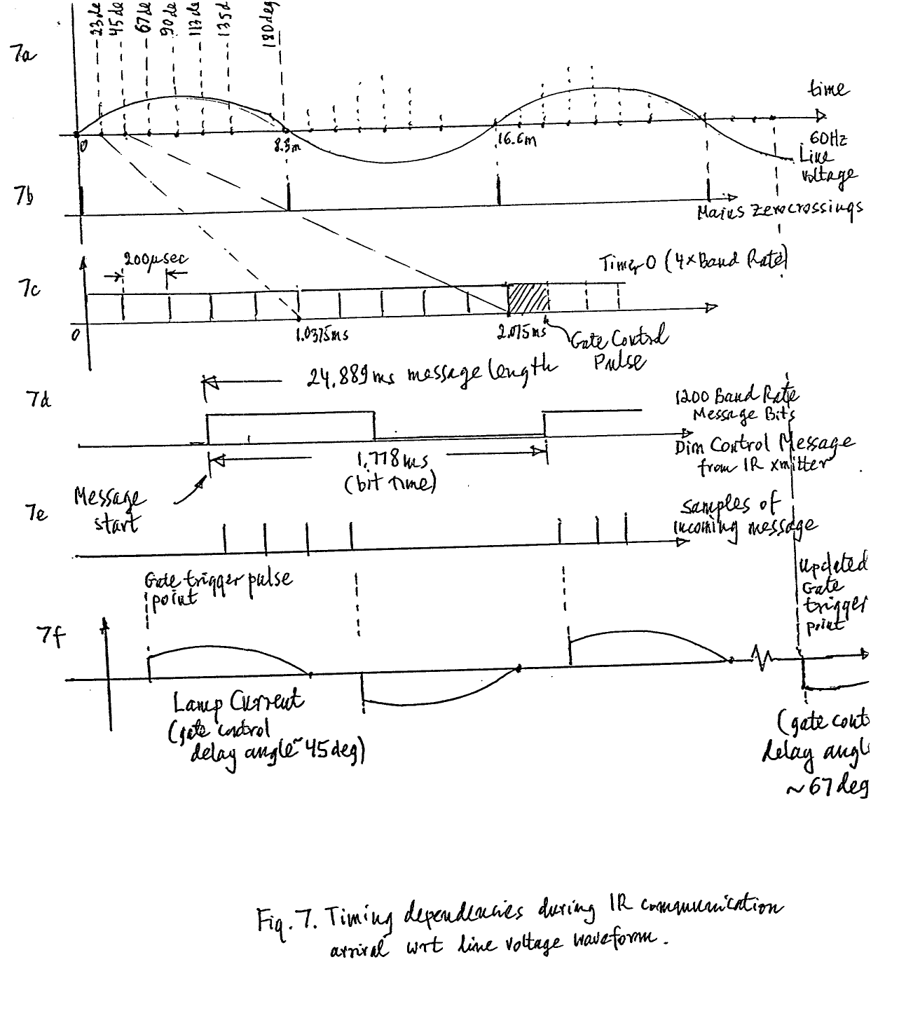

The illustration of FIG. 7a shows a seven-stop lighting controller with steps corresponding to conduction angles of approximately 0, 23 deg, 45 deg, 67 deg, 90 deg, 113 deg and 135 deg. This will control lighting in the range of about 15% to 100%. FIG. 7b illustrates four consecutive ac line zerocrossings whose presence initializes control and communication activity of the processor flow-charted in FIG. 8. Synchronized to the ac line is Timer 0 which starts at each ac line half cycle. Timer 0 runs at 4× bit rate and outputs 40 pulses of 200 usec each every half cycle, if there is no external interrupt 0 present, i.e. no infrared communication takes place. FIG. 7c illustrates Timer 0 pulse stream with indication of triac gate control pulse locations implementing the earlier mentioned seven-step light control task. Each mains half cycle, one of the 40 pulse stream is echoed to an output pin, such as pin 1.0, to trigger the triac at a predefined conduction angle, i.e. light output.

During mains half-cycle, occurrence of external interrupt 0 is being sensed. If external interrupt 0 becomes active during a 40 pulse time frame, the processor disables interrupt 1, stops and reloads Timer 0 to subsequently input the incoming message.

If the presence of infrared communication is detected, external interrupt 1 (mains sync) is disabled, see software flow-chart illustrated in FIG. 8. Timer 0 is stopped and the cycle timing coordinates are saved. A new time frame is being inserted, namely a 160-pulse frame of 200 usec long pulses which will navigate both, the receiving of the incoming communication and the outputting of the triac gate control signal.

First, during the 160-pulse sequence a 24-bit infrared communication message of RC-5 protocol will be received. As explained earlier, beginning with the start bit occurring on the serial interrupt line INT0, an interrupt will occur. At the INT0 service routine, the Timer 0 is loaded with a value that will result in a time delay of approximately a half-bit time of 4× incoming bit rate. Timer 0 reload register is loaded with a value that approximates a 200 usec bit sampling pulse rate. The program then returns to the main program, waiting for the timer to time out, generating an interrupt. At this moment, the serial input bit is half way through its duration and its sample is taken to check if it meets the criteria of a predefined start bit. If at the very same time the triac gate control is active, it is kept active until the above mentioned interrupt takes place. If start bit is not valid, Timer 0 is released and a synchronous search for external interrupt 0 commences.

If the start bit is valid, triac gate (if active) will be turned off and the program will then wait for the next Timer 0 interrupts to read the serial input and shift the value read into serial holding registers. This process will be repeated until all bits of the incoming message have been read on consecutive Timer 0 interrupts.

In the meantime, the process of transmitting the triac gate control pulses also takes place. Actual coordinates of triac gate turn-on angle are saved when interrupt 0 occurs. The coordinates will be offset-adjusted and translated into coordinates of the 160-pulse sequence. Timing of the output of gate control within the sequence duration will conserve approximate synch with respect to the ac line, whose zerocrossings are no longer controlling the triac gate when receive is in progress. When the 160-pulse sequence has been output, and the communication message is stored in serial holding registers, external interrupt 1 (mains zerocrossing) will be re-enabled. Received message bits may be error-checked and interpreted, and then the variable controlling triac conduction angle will be updated. New gate control outputting will commence under control of occurrences of external interrupt 1, i.e. ac line zerocrossings with Timer 0 reloaded back to 40-pulse sequences at consecutive line driven interrupts and new control pulse-slot updated accordingly to software protocol and received value.

Also, external interrupt 0, i.e. infrared communication, will be enabled by asynchronous search for a start bit of the next message will accompany triac gate control pulse transmitting.

As presented with earlier implementations, a LED diode may be connected to one of the processor I/O ports configured as output, to flash in synch with incoming infrared communication thereby providing the user with a visual feedback of successful system operation.

Although Philips RC-5 code is used with described remote control technique, receiver portion can be further modified to accommodate other wide spread protocols currently used by the audio/video market. There may be a selector switch(es) to be read by the microprocessor and different protocol baud rates and word coding rules can be inserted in the communication and control hardware and software. The software approach taken on in the presented implementation of communication and control code is general in character and the code can be modified to create a multi-protocol receiver.

It is evident that modifications/enhancements of the disclosed technology are possible. For example, an enhancement of address/install mode beyond just POWER command followed by using a look-up table to complete the protocol definition is doable. Other control command codes may be acquired in a similar manner as the POWER button code (for simple lighting controls only very few functions are needed so that the extended address/install mode when setting up a device would not take long). With the above enhancement, the size of ROM memory taken by look-up tables is reduced. There is, however, a minimum of protocol data needed to begin with, such as lengths of start pulses, defaults for code specific bit timing and bit numbers/message. Released memory locations may be used by software needed by an extended address/install mode, but the overall result is an increased number of protocols that may be used with the device.

Use of other microprocessors is also possible. There is the possibility of using a low-cost 4-bit processor available from Toshiba, for example. A 20-pin 2K×8 ROM TMP47C202 may be employed in an alternative execution. On top of 5 interrupt sources, it features two 12-bit timer/counters and an interval timer, among others. One of the 12-bit timer/counters, when put in timer mode, will perform what Timer 0 does in the disclosed execution. A second 12-bit timer, also in timer mode, can be synced with ac line zerocrossings to help generate output drive pulses for triac phase delay control in a way similar to the disclosed one with hardware and software shown in FIGS. 6, 7 and 8.

Microprocessors from Microchip Inc., such as the PIC12XX through PIC16XX series, are also good candidates. Some of them include ac line zerocrossing hardware on-chip, thereby reducing external hardware needed otherwise. Also, various on-chip timer/counter hardware is available which may be employed to implement clone executions of the introduced technology.

Finally, the infrared receiver hardware employed in the disclosed execution is designed for use with carrier-modulated infrared transmitters. There are simple infrared communication formats that do not use modulated signals and transmit pulses of unmodulated infrared wave. It may be seen by those skilled in the art that different receiver hardware needs to be used with unmodulated transmissions. This may be implemented as another execution of the disclosed technology; also, there is a possibility of combining both kinds of receivers to enhance the disclosed technology.

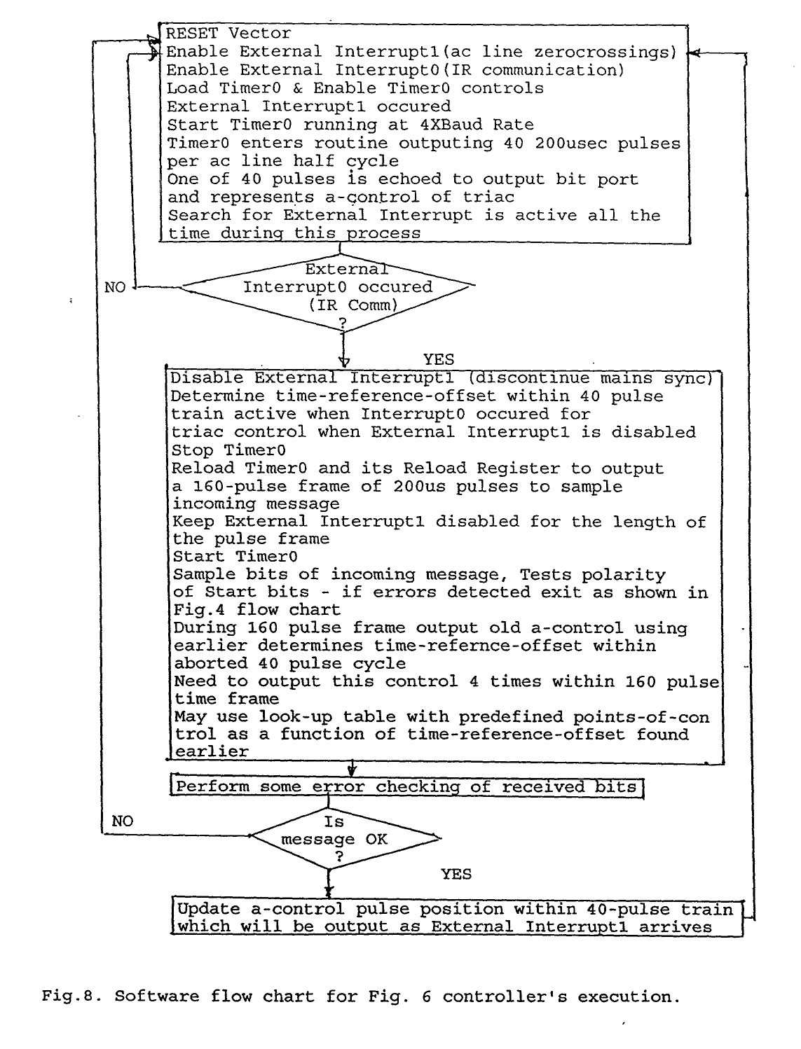

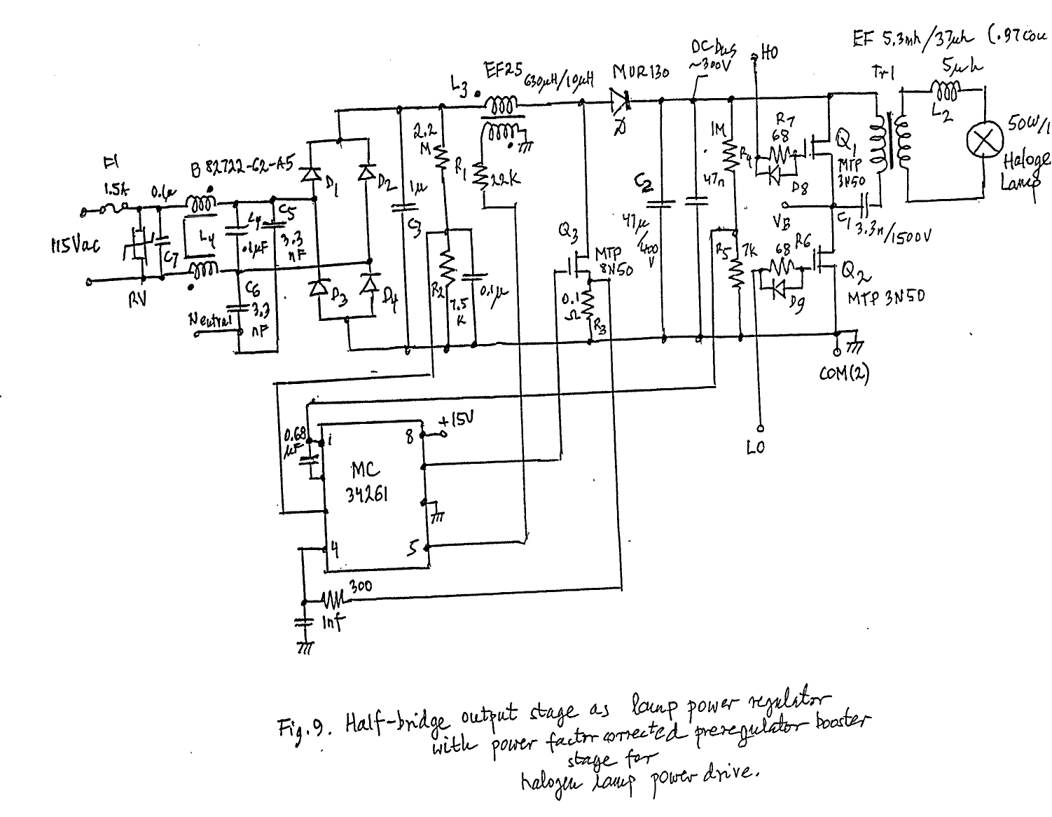

Another application for using this kind of control and communication technique is in the area of lighting employing halogen light sources. The circuitry shown in FIGS. 9 and 10 discloses a detailed solution of control and power regulation of what is termed a lamp with an extra-low-voltage halogen burner (6V, 12V or 24V types of less than 100W output, as opposed to mains voltage types which fall controlwise in the category of applications described earlier in this disclosure).

FIGS. 9 and 10 circuitry is a electronic transformer capable of dimming a low-voltage halogen lamp in a range of 15 to 100% and operate it from a infrared remote controller. An essential accessory for the operation of extra-low-voltage halogen lamps is the transformer to deliver correct lamp voltage. Conventional magnetic transformers and electronic transformers must be distinguished—dimming of low-voltage halogen lamps is not a straight-forward matter, due to the presence of a transformer and with restrictions, current wall dimmers may be used with conventional magnetic transformers: the restriction is that a functioning lamp is present, otherwise a conventional transformer will heat up to very high temperatures that can result in melting or damaging a luminaire. Thus for these reasons electronic transformers with variable output power offer a better solution.

A central portion of the FIG. 9 halogen power regulator is a switched-mode power supply comprising a half bridge with MOSFET switches Q1 and Q2 and damped resonant tank implemented using a high voltage capacitor C1, leakage inductance of transformer Tr1, a secondary choke L2 and halogen lamp operation resistance. To regulate power delivered to the lamp, half bridge operating frequency is varied from about 100 kHz at 100% output power to about 170 kHz that corresponds to about 15% output power. The transformer core is gapped to reduce magnetization inductance so that the power stage may operate with high efficiency and safely under intentionally reduced loads in the event of a no-load (defective lamp).

Additionally, the choke L2 during turn on of a cold lamp or in the event of a short circuit in the socket has a current limiting effect. Further current limiting during turn on will be implemented by a microprocessor control so that the on lamp power up power circuit starts at a lower power range (soft start) where currents are much less harmful. Also, a slow blow fuse, such as o.8 s one, (not shown in FIG. 9) may be included on the primary side of transformer Tr1 to protect the power stage under short circuit. A complete protection with some added cost would be guaranteed by possible use of a current transformer, also not shown on the schematic, to monitor primary or secondary current. The power stage specific component design values are applicable for a 50W 12V halogen lamp load.

The half bridge power stage is powered by a DC bus of about 300V. Here, the DC bus is obtained as an output of a pre-regulator built around a switched-mode step-up converter with MOSFET Q3, diode D, choke L3 and capacitor filter C2. The pre-regulator connects to the utility via D1 through D4 bridge rectifier and a filter capacitor C3 to derive raw DC voltage. To enhance poor power factor loads such as the ones used, a MC34261 power factor controller operating as a critical conduction current mode power factor controller is used. Mains voltage is sampled by voltage divider R1-R2 and delivered to MC34261 multiplier input. Power stage critical current conduction is monitored by an extra winding used with choke L3. Current peaks of Q3 are detected by a shunt resistor R3. Q3 operates a switch whose conduction is initiated when choke L3 current reaches a certain predefined maximum. Switching frequency of the Q3 varies, dependent on the instantaneous mains voltage and load, and in the case of the FIG. 9 circuit it is in the range from about 40 kHz to about 70 kHz. MC34261 output stage directly drives pre-regulator switch Q3. FIG. 9 is capable of processing up to 80W power throughput and a 300V DC bus is obtained at its output capacitor C2 with a good regulation with respect to line and load variations performed by MC34261 error amplifier sensing DC bus via resistive divider R4-R5. At the input end of the power stage there is a fuse F1, varistor RV, RFI suppression choke L4 and switching noise filter capacitors C4 through C7. IC MC34261 is powered by a 15V auxiliary power source.

To implement halogen lamp power adjustment, half bridge Q1-Q2 operates, as mentioned earlier, under variable frequency delivered to switches at points marked HO, VB (high side switch) and LO, and COM (2) (low side switch). The high frequency drive signal with floating channel operation is derived from the output of IR2110 driver shown in FIG. 10. The driving square waves are 180DEG phase shifted waveforms whose frequency varies in the range 100 kHz to 170 kHz, as required by the lamp power range design specification. The outputs of IR2110 are capable of delivering required currents and are coupled to MOSFET switches Q1 and Q2 via resistors R6 and R7 with diodes D8 and D9.

By varying switching frequency of half-bridge MOSFETS Q1 and Q2 the power delivered to the lamp load is adjusted according to user presets. Variable frequency operation is achieved at the output of Pulse Width Controller IC MC 3526. The MC3526 chip is primarily intended for use as a constant frequency PWM switching controller. Here, the functionality of this IC was enhanced and it is configured to operate as a variable frequency variable duty factor switching controller. The variable frequency feature is achieved by modulating current through timing resistance at pin 9 (R) which defines current driving timing capacitance at pin 10 (C). Frequency of operation is twice higher than what is required to run the half bridge in the range of output power of interest here. MC3526 output at pin 13 (OUTA) is connected to clock CLK pin of a J-K flip-flop implemented using MC14027 CMOS IC. The outputs Q and Qbar of the J-K chip produce square waves whose frequency is half of that driving clock input and of 50% duty factor. In this way symmetrical variable frequency 180DEG phase shifted square waves are produced which in turn drive inputs LIN (logic input for low side gate driver output LO) and HIN (logic input for high side gate driver output HO) of IR2110 half-bridge driver chip.

Frequency modulation of MC3526 operation is achieved using a small signal pnp transistor Q4 such as a 2N3906 whose base is driven by a voltage signal defining current flowing through pin 9 and thus operating frequency.

Base drive voltage, and in effect power delivered to the lamp load, is output by a DC smoothed PWM waveform produced by a 87C752 microprocessor in exactly the same way (software and hardware solution) as was described earlier for the incandescent dimmer of FIG. 2.

This completes the description of the FIGS. 9 and 10 arrangement. The only means used here to obtain lamp power regulation is by regulation of the DC bus powering the half-bridge against line and load variations. There could be, at added cost, another closed loop used to better monitor the lamp operating point as the lamp is aging and to adjust the power in a more precise way than the arrangement of FIGS. 9 and 10 can accomplish. This, however, is a further extension of lamp output control quality. An alternative configuration is illustrated in FIG. 19 below and the accompanying text.

The presented single lamp control arrangement can be further extended and used to control a number of light sources. A central receiver of infrared control communication with a microprocessor such as the one described in this disclosure might be hard wired with individual power stages—electronic transformers (pre-regulator and half bridge operating a single lamp) and in this way a number of light sources could be controlled from a hand-held infrared transmitter.

A more advanced extension of lighting control technology introduced in this disclosure is implementation of flexible lighting schemes offering possibilities of changing the topology and functionality without the need for any modifications of fixed hard-wiring. Here, in addition to having the capability of responding and performing control functions, such advanced schemes require capabilities of handling two-way communications, which via software messages can organize their databases leading to implementation of flexible topologies according to user's needs. The flexible topologies would then be interpreted as a software view of the network and executed by a powerful control and communication platform.

In lighting systems, as in any control systems, controlled objects are connected to their physical media. The physical attachment only provides a path for the device to communicate, it does not tell the device the system it belongs to or with whom it should share data, and therefore it is not enough to operate the system. Specifying this additional information is required when creating such advanced systems, hence the need for what may be called an installer tool. Such a tool would be used to define all of this information after the controlled objects are physically in place by sending messages to each device over the network. On top of that, this tool would be then able to perform various control functions and all this activity would be implemented using infrared communications as a primary communication channel between the user and the system. A hardware and software execution is the subject of the final portion of this disclosure and a detailed description follows.

Here, the particular execution of the installer tool is, for example, a ceiling mounted device capable of accepting infrared messages from the user (installer), decoding and executing control and network messages. To input a control message sent by an infrared transmitter, the same type of solution may be used as the one described with the circuit shown in FIG. 2, i.e., a microprocessor with an infrared receiver capable of inputting and presenting an image of the received message for further processing. Further processing would be carried out by a standard control-and-communication platform capable of managing a network, i.e. its address database, as well as transmitting over the network control messages for final executions by lamp power processors, such as the ones presented earlier in this disclosure. Such a communication platform may the one known as LonWorks Network developed and distributed by Echelon Corporation. This particular platform is executed using a proprietary communication protocol (software portion) and a dedicated microprocessor called Neuron with a communication transceiver allowing an interface with the user and providing a physical attachment with the network (hardware). Network will be understood as a set of nodes, here in the form of lighting fixtures capable of interpreting and executing control and communication messages.

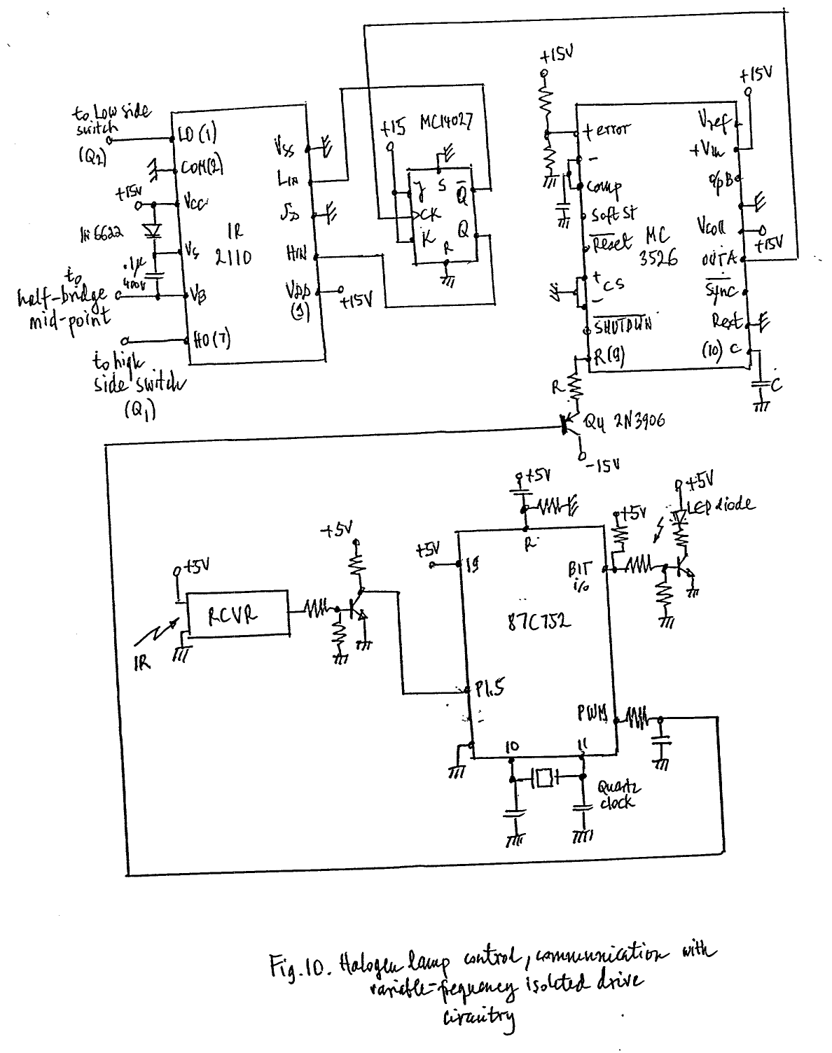

To get into details of the particular solution disclosed in this document, FIG. 11 illustrates execution of said ceiling mounted device (installer tool) capable of receiving incoming infrared communication and control messages, processing these messages, outputting signals for further use within the network, providing some simple visual communications with the user about the status of certain messages for execution and implementing hardware for physical attachment with the network.

An infrared communication receiving part of the circuit in FIG. 11 is practically the same as that disclosed in FIG. 2. Infrared receiver RCVR inputs messages and presents their signals to a microprocessor, such as an 87C752, for further processing and outputing in a simplified form to a communication processor built around the afore-mentioned Neuron chip. Software operating on 87C752 processor is borrowed from the execution accompanying FIG. 2. The 87C752 also provides a visual feedback with the user by flashing a LED, LED1, when a message is being accepted. The unfiltered PWM waveform available at the PWM output of the microprocessor provides a representation of the decoded message in the form of a predefined on-time value of the PWM signal (the time interval when this signal is at its high analog level). The bit output operating LED1 is also used as a line signalling the Neuron chip when the waveform available on the 87C752 PWM output may be considered as stable and accepted by the Neuron as a valid input. The signals introduced above connect to Input/Output port (also termed as I/O or application port) of the Neuron processor.

In this way, when using Philips RC-5 code, for example, 64 for serial messages sent by infrared transmitter, will be input and presented in the form of predefined on-time values of an accurately defined period wave for further processing by the Neuron chip.

The circuitry placed around the Neuron chip includes memories, EPROM and RAM memory chips, (see FIG. 11) storing system image and immediate operating data, as well as simple logic gates decoding (specified on FIG. 11) address lines to accomplish proper timing of required data (D-pins) and address (A-pins) bus transactions within this mini-computer-like environment.

Upon reception of an on-time coded message, the Neuron chip via its operating application software described later in this disclosure performs required control or network related action. The Neuron chip communicates with the rest of the nodes (a node is a light fixture with a lamp power driver and a Neuron chip) via a specific transceiver allowing the physical attachment of FIG. 11 hardware to the rest of the network. The transceiver is executed here with a twisted-wire pair communication media, which means that message exchange within the system built of light fixtures is done over a dedicated low voltage wiring. This latter might be an extra wiring added under the plenum, which may be justified cost wise in new installations and in some cases of refurbishment; sometimes, if possible, unused telephone lines, could be employed.

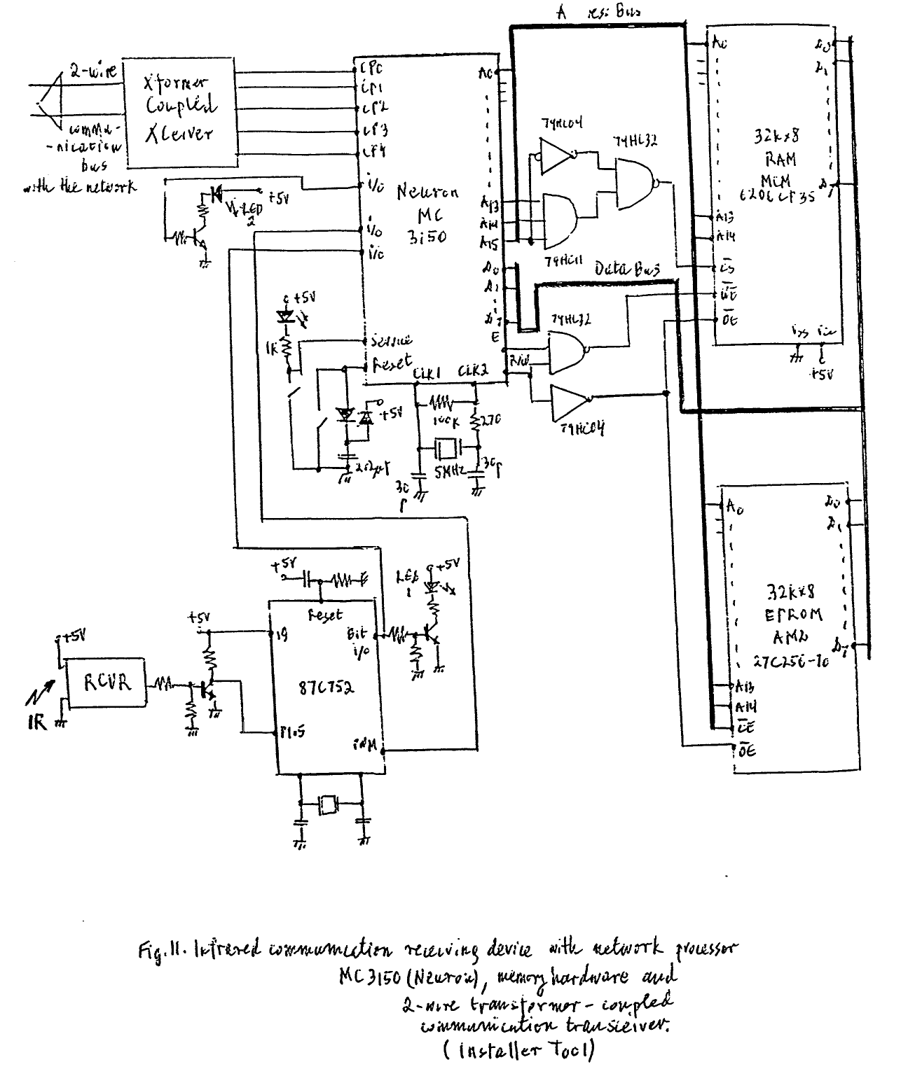

FIG. 11 illustrates a block diagram of a twisted pair transceiver XCVR (such items are commercially available) connected to Neuron chip communication pins marked as CP. Other communication media within the Neuron network are possible. If, for example, a line-of-sight pathway is available within the network, infrared might be used not only as a user's interface media but also as network media. It is felt that other media types, such as the one employed here, are more general in character. A block diagram of the network topology is shown in FIG. 12.

Neuron chip operating software via one of the I/O pins directed as output provides simple visual information for the user about the completion of required activities (busy signal) so that the user when performing network database programming, e.g. flexible functionality requiring a number of steps and of course some time, receives a confirmation of a successfully completed transaction. Here, LED2, would be on when there is no network-activity-in-progress. This would indicate network availability. While performing installation steps indicated by messages issued by remote control, LED2 will be off meaning a busy signal. Upon successful completion of a transaction it would go on again.

Since the idea behind this particular solution is functional flexibility of the lighting scheme, such as a rewiring without hard-wired routing modifications, the nodes of the scheme must be able to flexibly change their databases and communication pathways. The above features are a built-in Echelon Corp. LonWorks solution and there are numerous documents covering this subject. To continue further discussion of the solution introduced in this disclosure, it will be pointed out that before required lighting functions have been made executable, the network, of to a large degree uncommitted communication-wise nodes, has to be established and this is what is called installation or a process of creating logical network interconnections.

In the case of the lighting system described in this disclosure customization of a generic node to give it unique network personality involves specifying and loading pieces of information needed for site-specific address assignment and its modification such that functionality of the lighting system installed in a room can be flexibly changed according to user's needs. After required network structure content has been established in the process of creating logical addressing, control commands may be executed to implement desired lighting tasks. In other words, after all of the above is done, lighting fixtures will be organized in groups capable of executing group-specific lighting tasks. And, of course, the group structures may be flexibly changed if any future need arises.

The above process will be implemented using an infrared transmitter which is capable of combining both, the function of an installer tool and a controller.

Messages transmitted via such a device will be interpreted by software operating on a receiving device according to predefined rules: some as network messages leading to network logical structure definition, and some as control messages allowing the execution of control functions.

The repertoire of network messages, a product of Echelon Corp., is defined by communication protocol and Neuron chip operating software. Software residing on a receiving device Neuron chip will execute required network messages upon reception of infrared communication and presentation of its contents to an I/O port of a Neuron chip.

Below, a description of the software capable of execution of the steps required to achieve the required network structure when a network is created from generic building blocks is described.

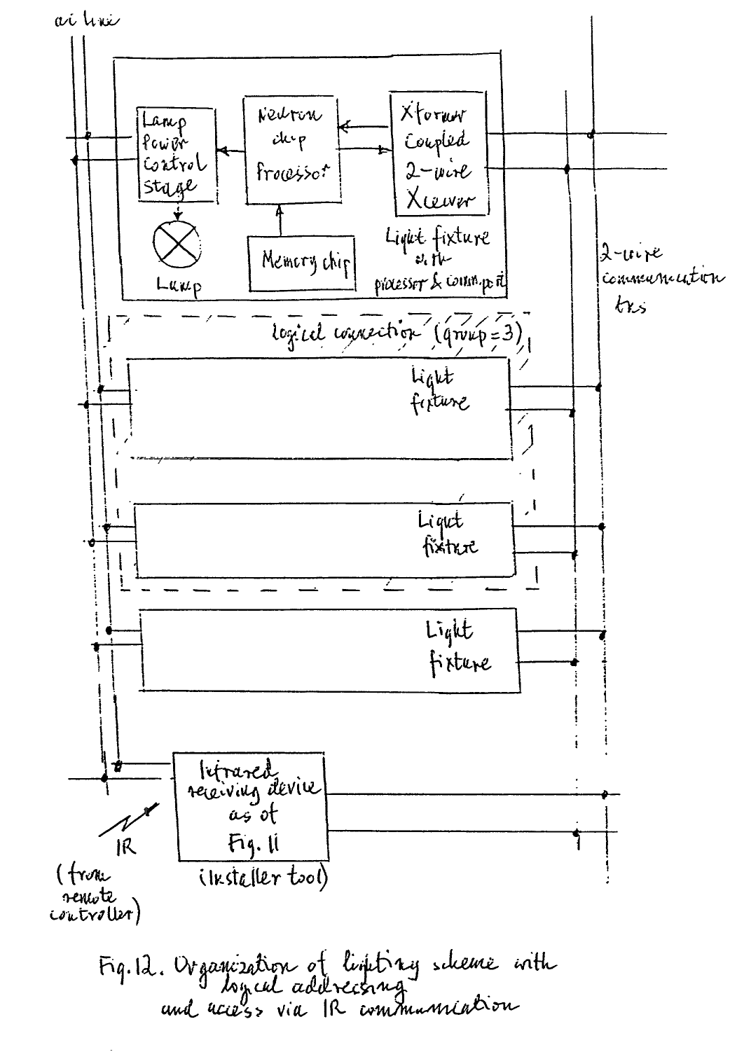

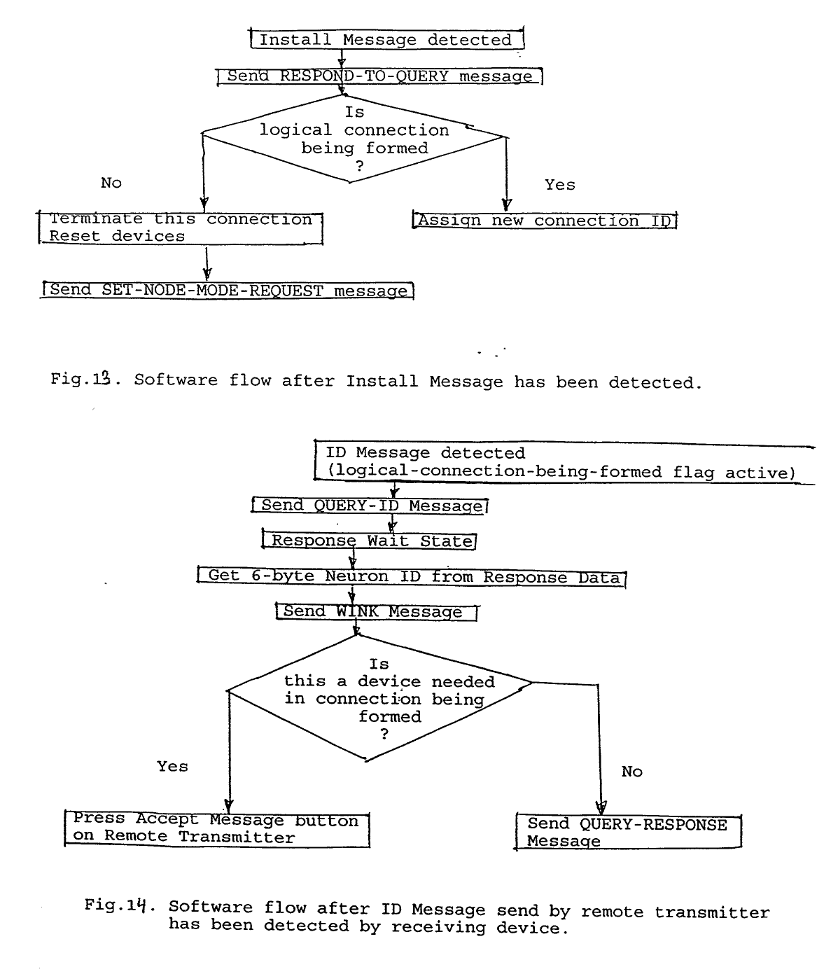

Flowcharts shown in FIGS. 13 through 16 illustrate software involved in execution of various tasks. Detailed software listing accompanying these flowcharts is a code written in what is called neuron C (based on ANSI C), which is a form of C enhanced to support I/O, event processing, message passing, and distributed data objects. Its extensions include software timers, network variables, explicit messages, a multi-tasking scheduler, EEPROM variables and miscellaneous functions.

As mentioned earlier, the process of installation has a number of steps which must be executed in a proper sequence. Each step is initialized by the user when pressing the proper button on the transmitter.

First, the user puts the receiving device into installation mode by pressing a transmitter button and sending a message via the infrared communication channel. The flowchart of FIG. 13 illustrates event processing after the Install Message has been detected. In response the Neuron operating software sends a broadcast message RESPOND-TO-QUERY-REQUEST which explicitly selects and deselects nodes to respond to a QUERY-ID message (the bold-faced messages are defined by Echelon Corp. product). Next, actions depend on the fact whether the installation/connection being built is initialized or terminated. In the case of initialization, a new connection number is assigned first. This number will provide one of the coordinates of the database stored in the hardware of the receiving device (receiving device is installer tool here) and one of the coordinates of the network address of the lighting fixture being installed. Also, this number may be in some way presented to the user. It should be pointed out the address assignment is totally automatic and handled by receiving device software such that all network addresses are unique and the user (installer) has no input on possible address number selection and assignment. The above applies to both, the installation of a brand new system (first time installation) and future modifications, rebuilding, replacement, etc. of single light fixtures or even groups of the existing system.

In the case of termination of logical connections being built, all the nodes (light fixtures) in the connections will be sent a RESET message. The RESET message is a form of SET-NODE-MODE request message, and a node in the soft off-line state will go on-line when reset. After Install Message has been detected and processed, installation my be carried out using what is termed the query and wink method. In FIG. 14 the flowchart illustrates what happens when a query and wink installation is being executed. First a node (lighting fixture) identification message QUERY-ID-REQUEST is sent. This message requests selected nodes to respond with their 6-byte Neuron chip ID(assigned when chip is manufactured) and 8-byte program ID (given when writing application program). This message is typically of a broadcast type and can be used to find unconfigured nodes. Nodes selected with RESPOND-TO-QUERY-REQUEST message of FIG. 13 will respond to this message. The response message QUERY-ID-RESPONSE contains node identification bytes. When this response arrives, installer's device software copies its contents and assembles a WINK message which will be sent next. A node receiving WINK message executes a wink clause which tells the node to blink its lamp. In this way physical location of a particular lighting fixture is identified, so that the installer can make a decision if this particular fixture is supposed to be a part of the connection being formed or not. If not, then RESPOND-TO-QUERY-REQUEST message is sent to the fixture resulting in deselecting the fixture to respond to subsequent QUERY-ID-REQUEST message sent when carrying out further steps of building the logical connection being formed. Then the installer sends an Accept Message by pressing a dedicated button on the infrared transmitter.

When the installer's tool (receiving device) software detects an Accept Message, it proceeds to execution of task flowcharted in FIG. 15. In general, the installer tool needs to keep track of the network database as the network is being installed and modified. The information includes data specific to software view of the communication protocol and data specific for a particular network being built, such as specific Neuron chip IDs, group IDs (lighting fixtures are connected in groups), number of nodes in the network, number of groups created within the network and number of nodes within each group.

With the database so created, each time when a node (light fixture) presents its ID, the database is searched to find if this is a new node or a node known to the database. If this node is already in the database and its group ID is equal to the ID of the connection being formed then it is an attempt to add a node which is already in, and thus the message is ignored. Otherwise, the node, which is known to the database, is going to be removed from the connection it is in. To execute this action, the message UPDATE-GROUP-ADDRESS-REQUEST is sent (see FIG. 15) to all members in this connection to inform them of a new size of connection. This message updates a group entry in the address table with a new group size. A node receiving this message can take up to 130 ms to execute it.

If a node is a new one, i.e. not in the database, the software assigns a unique network address. After the database has been updated, a message labelled as UPDATE-DOMAIN-REQUEST is sent to update the network image written during node installation and, among others, a node identifier is assigned to the node.

When either execution of UPDATE-DOMAIN-REQUEST message (a new node case) or UPDATE-GROUP-ADDRESS-REQUEST message (a case of a node whose identification info is already in the database), the FIG. 15 software proceeds to change the node operating state so that application software can run. To this end the message SET-NODE-MODE-REQUEST is sent.

After successful completion of this message, a connection identification number and a connection member number will be assigned. To this end UPDATE-ADDRESS-REQUEST message is sent which overwrites an address entry table with a new value. When this message execution completes, the size of the logical connection being formed is incremented. To complete the installation process, UPDATE-GROUP-ADDRESS-REQUEST message has been executed. When this message is sent, a group entry in the address table is updated with a new size of the logical connection. The installation of the lighting fixture is completed, and what the installer may wish to do next is either terminate this connection by sending Install Message from the remote controller or start installing another fixture within the same connection by repeating steps described above.

It should be noted that at the exit of this part of the software, modification of the address tables takes place on the installer tool (infrared communication receiving device) itself. In this way, the installer tool may be then turned into a controller capable of executing control commands within the connection of nodes it belongs to at a given time.

When the time comes to execute control functions on the network so created or network-related manipulations such as replacement of a fixture or reconfiguration of network topology, groups within the network are addressed first and then further steps are carried out. To this end a Dial Button on the remote controller is set to a numeric value corresponding to the group address of lighting fixtures needed in a given case. If dial is 3, for example, then receiving device software will assign 3 as a group ID in the communication transactions that will follow. Receiving device software will modify device's address table such that receiving device will be a part of group whose address equals to 3. From then on, control messages transmitted by the remote controller will be interpreted by the receiving device application software as control commands to operate light levels of fixtures belonging to group 3.

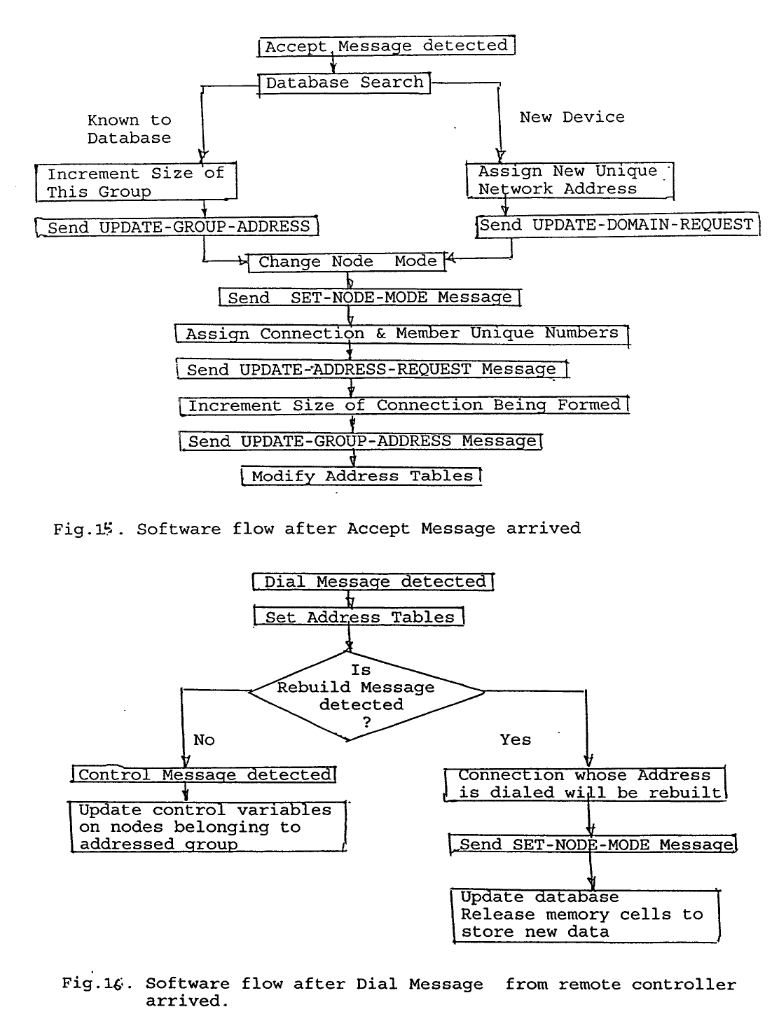

If there is a need to modify the group 3 structure, replace or rebuild connection, then after Dial Button address was presented to receiving device a Rebuild Message needs to be forwarded by remote controller. When this message is detected by the receiving device, then group address 3 will be used in further network transactions. The flowchart of FIG. 16 illustrates what actually happens. When network transactions are going to be executed, then SET-NODE-MODE-REQUEST message will be sent and as a result the network database which resides in Neuron chip EEPROM will be updated, i.e. the nodes of the rebuild or replaced connection will be removed from the network database freeing parts of the EEPROM memory for a newly built database.

FIG. 17 illustrates a schematic diagram of an infrared controlled power driver operating an incandescent lamp 116 or any practical number of lamps. There is no limitation on the power rating of the installation, as there is no requirement to use a particular control protocol. For simplicity, one light source is shown.

Circuitry depicted in FIG. 17 may be implemented in a form of a plug-and-play box where the mains outlet and lighting fixture terminate. This box could be plugged into a mains outlet, for example. Infrared receiver U8 would be preferably located on an outward facing surface. The receiver is a wide-band AM detector/amplifier whose passband center frequency is about 36 kHz, for example. Receiver amplitude and phase characteristics are shaped such that infrared communication using carrier frequencies in the range of approximately 20 to 50 kHz can be received with negligible phase distortions. On the other hand, the passband is such that low frequency interferences, such as those related to power line frequencies, are well damped. An example of such a receiver is a commercial receiver available from LiteOn Inc.

Two LEDs are used with the circuitry to signal power-on and communication events (Red LED D3) and indicate status of address assignment when the device is logically installed with a control environment (Green LED D4).

The ac mains of 110/220V 50/60 Hz is applied to the circuitry at points marked Hot and Neutral. In the preferred embodiment, a capacitive low cost line ballasting is used to derive an auxiliary power supply of +5VDC to power controller hardware. Another execution may use a transformer-coupled power conditioning. Inrush current limiting resistor R1, ballasting capacitor C18, diode rectifiers D1 and D2 together with filter/limiter C1, R2, C2, R3 deliver a raw DC which is further regulated down to +5VDC at the output of voltage regulator U2 such as LM78L05. Also, the ac line is sampled by voltage divider R10 and R11 so that zerocrossings of the ac line may be detected and processed by comparator U3-a, such as LM393, whose output is the ac line synced square waveform as shown in FIG. 3. The output of the comparator is inverted by buffer U4-a, such as CD4049, whose output drives base of npn transistor Q1 (2N2222) used to periodically discharge capacitor C12. Transistors Q2 and Q3 (2N2907) together with resistor R23 and capacitor C12 form an ac line synced sawtooth waveform oscillator whose on-time equals approximately the ac line half period. The oscillator cycle is initialized by comparator U3-a when transistor Q1 is turned off. The voltage across capacitor C12 is further compared with the DC reference voltage applied to the negative input of comparator U4-b, LM393, see FIGS. 17 and 3. When sawtooth voltage exceeds the DC reference voltage, comparator output undergoes a low-to-high transition, which in turn provides a trigger for monostable multivibrator U5-a, such as CD4538. U5-a produces pulses whose approximate length equals the ac line half period, which are next fed to second monostable multivibrator U5-b and differentiating network C16 and R27. Outputs of differentiating network and multivibrator U5-b deliver pulses whose approximate length equals 200 usec, see FIG. 3.

The pulse trains so obtained are further wired-OR by D6, D7 and R28. The resulting pulse train is next buffered by U4-b and paralleled U4-c through U4-f buffer/current driver (all CD4049) and delivered to resistor R30. Resistor R30 feeds the drive to LED of optoisolated triac U6, such as MOC3012. The U6 output drives the main power triac U7 operating a given load. Here, U7 is a power triac such as 2N6071 which is used to run a 200W incandescent lamp load, for example. The drive waveforms developed by the disclosed circuitry are shown in FIG. 3.

It may be seen from the above description and waveforms that power triac U7 conduction angle defining level of load(lamp) power is derived from the DC reference voltage at the negative input of comparator U3-b. This voltage is derived from microprocessor output as a response to control messages transmitted via the infrared communication link.

The receiver U8 output pulse train is presented to two I/O pins of a microprocessor based decoder. A Philips low-cost 87C749 8-bit microprocessor based communication decoder is suitable, and its operation is described in greater detail below. Using two I/O pins for communication processing allows for reliable decoding of a variety of infrared communication formats, namely, bi-phase codes which have single-valued bit cell times are reliably processed by an external interrupt input, whereas pulse-distance codes whose bit cell times have two values are efficiently processed employing a standard I/O input pin.

A quartz clock, X1, running at 10 Mhz rate, for example, provides timing for software execution. Two I/O pins drive LEDs D3 and D4 to provide the user with a simple indication of system status. A dedicated Pulse Width Modulated (PWM) output available with this processor is programmed to run at a fixed frequency and variable duty factor. Variations in the duty factor are a form of coding of control messages. This output runs at 10 kHz rate, and its output waveform is further DC filtered by the R8 and C9 combination, whose output is a DC reference voltage and which amplitude is a function of the duty factor. This DC reference voltage is applied to comparator U3-b and defines power level demand.

The software residing in ROM of the microprocessor can interpret many communication protocols whose carrier frequency is within the passband of receiver U8. For example, with 87C749 chip and its memory size budget, 22 control protocols can be accommodated (more specifically, codes of 22 commercial audio/video brands).

The software is designed such that the process of address assignment is implemented by a device's acceptance of one of 22 control protocols stored in processor memory, and thus at the beginning of installation of the device, its software recognizes the logical address by looking at specific characteristics of a code dedicated for use with the device.

Before going into details of further application software, the characteristics of representative protocol types used for audio/video equipment are introduced.

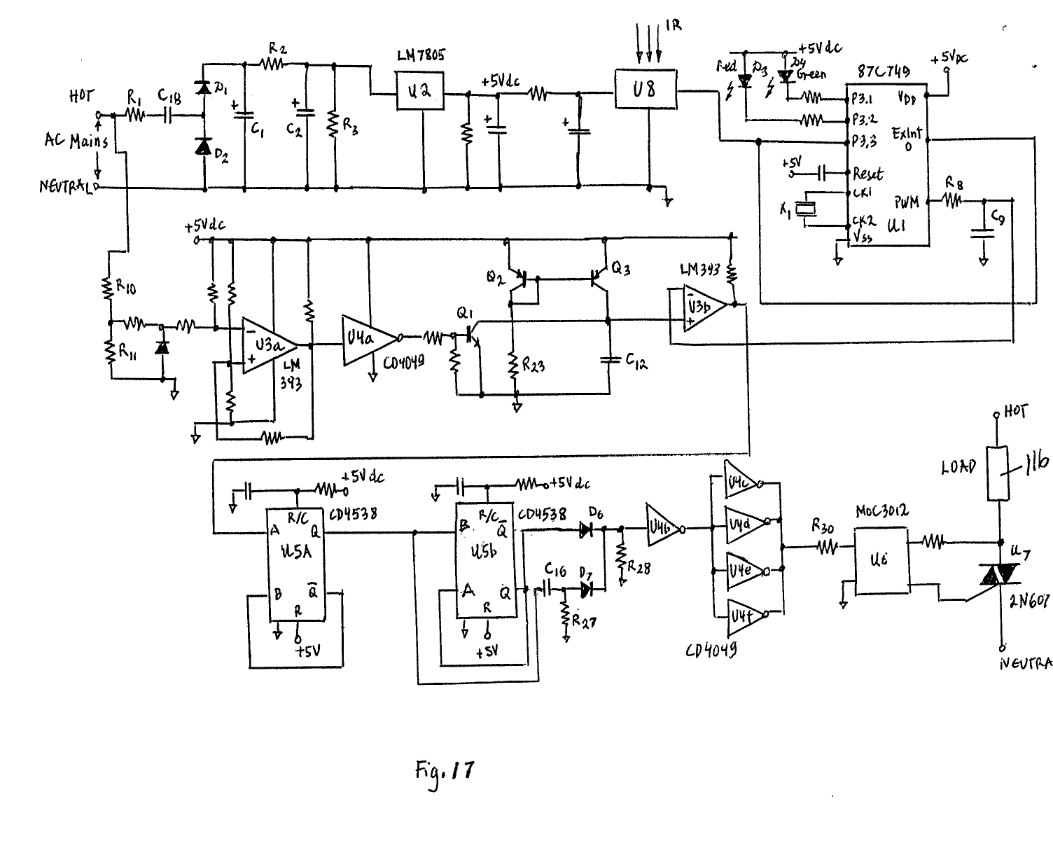

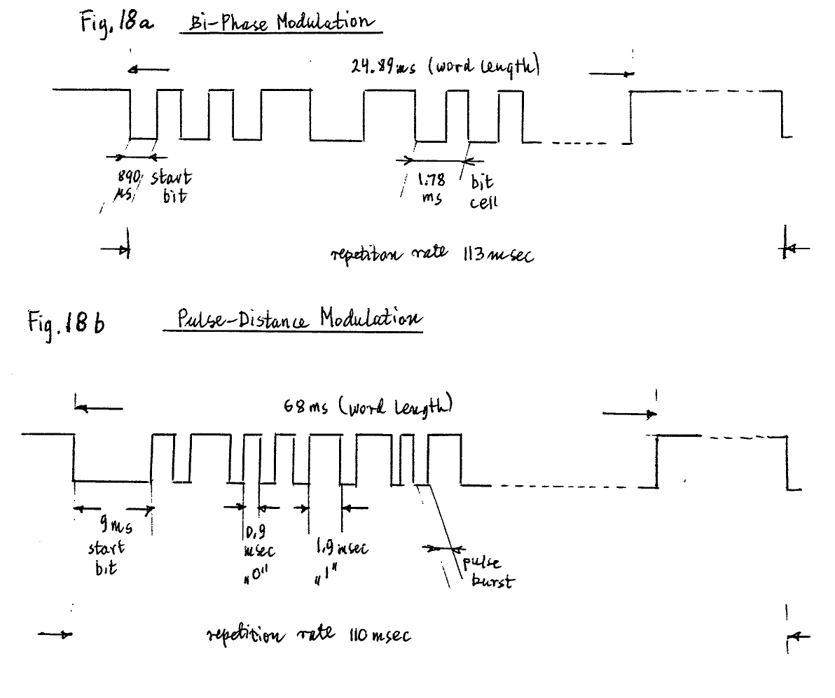

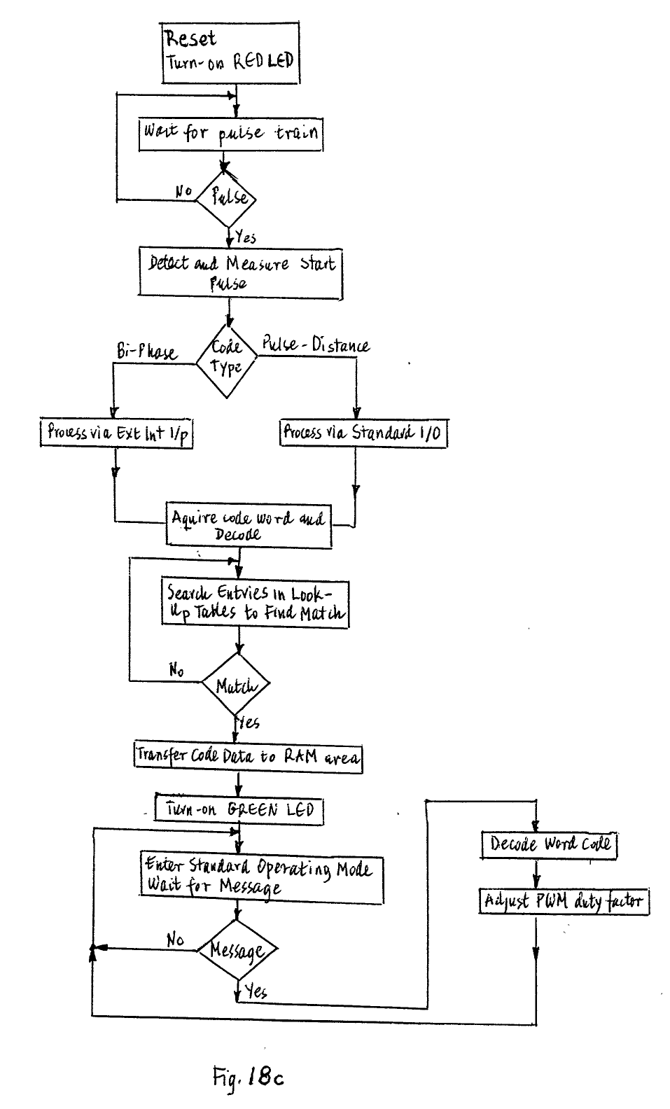

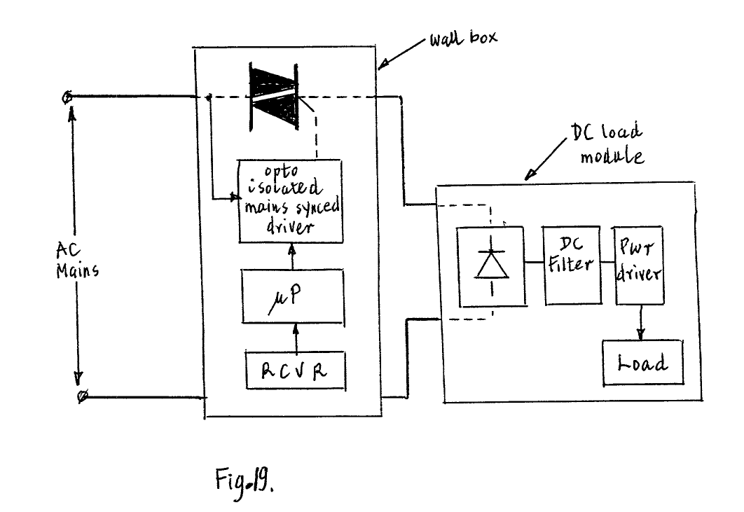

The codes used with commercial audio/video equipment are subject to standardization—message format, command allocation, addressing, etc. are fixed and may not vary. A bi-phase code, such as Philips RC-5, has words of 14 bits: startbit, fieldbit, controlbit, 5 systembits and 6 commandbits. The code is of bi-phase type where bit values are determined by pulse edge in the middle of the bit cell. The time of the bit cell is 1.778 ms. A code word of 14 bits lasts 24.889 ms. Code word repetition rate is 113.778 ms (see FIG. 18a for illustration). Startbit is the first bit in the code word, it is always 1. In six command bits, 64 different commands may be coded. For simple lighting applications only a few are needed, namely, power on and off, dim up and down, a number of presets for specific task light levels, and a programming key. And, of course, certain keys of a standard audio/video remote controller can be assigned to execute the above functions—volume up and down keys may be assigned to execute dim up and down commands, for example.

Another type of widespread protocol format used by a commercial audio/video maker is a pulse-distance code. Typically, a series of bursts of pulses are sent by a remote transmitter (for example, a burst may have 10 pulses of 50 usec each). The position or difference between bursts identifies logical 1 or 0 to make a code. Position or distance is determined as the amount of time between the rise of the first burst and the rise of succeeding bursts. Also, there is a pulse initializing the code word. Its length may be, for example, 9ms. The logical 1's and 0's may correspond to 0.9 msec and 1.9 msec, for example. There may be a series of 32 bursts in a single code word which may result in a code word length of 68 msec, for example, at a repetition rate of 113 msec (see FIG. 18b for illustration).

FIG. 18c illustrates the decoder software flow. The microprocessor employed to execute decoder software offers the advantages of the Intel 8051 architecture in a small package and at a low cost. It contains a 2K×8 ROM, 64 bytes of RAM, 21 I/O lines, and a 16-bit auto-reload timer/counter, a seven source fixed priority interrupt architecture and, among others, a PWM output. It does not have a hardware Universal Asynchronous Receiver/Transmitter (UART) on-chip. Thus, some of the software routines execute a kind of UART function implemented with a microprocessor without the benefit of hardware UART.

Two processor I/O pins connect to output of receiver U8. As mentioned earlier, bi-phase protocols are processed by external interrupt input pin P1.5, while pulse-distance codes are input via a standard I/O pin such as P3.3.

After chip reset initialization, red LED turns on to signal power-on event, whereas green LED is off—meaning that control device is in a logically uninstalled state (no address assigned yet). User makes decision which particular protocol (one of the 22 whose images are stored in ROM) will be servicing the control device, and device's acceptance of a message using this particular protocol completes logical address assignment/installation. Thus, after reset, software enters what may be termed as address/install mode where it recognizes certain protocol specific characteristics. As mentioned earlier, protocols differ, among others, in code type, length of message, timing of data bits, timing and structure of start sequence, repetition rate and format and number of bits/message. Here, the first pass of address/install mode is implemented by measuring the length of start pulse which occurs after first bus transition. Start pulse length of the 22 protocols that this software execution can recognize takes on values in the range from approx. 880 usec to 9.2 msec.

After start pulse length has been identified, code type flag is assigned, so that code type-specific data inputting may be implemented. It should be pointed out, that in the phase of start pulse identification only I/O pin P3.3 is used. From then on, the two earlier introduced I/O pins are active. Next, the codes whose start pulse length equals the value captured are tested against an incoming sequence.

Software image of 22 stored codes is such that the codes are grouped in accordance with start pulse lengths. Therefore, a second pass of address/install mode is entered, where software operates under two control attributes, i.e., code type and specific code group.

In ROM of microprocessor, look-up tables store protocol and data information specific to a given code, and when a given code group is searched for a match, the look-up table values are used for timing the code reception, measuring lengths of intervals of interest and finally identification of contents of commandbits of a message. In this particular software execution, POWER button message sent by a remote is used during address/install mode.

The data stored in look-up tables contain description of bit cell timing, length of message expressed in terms of bits/message, message bit segmentation pattern to derive commandbits for comparison with reference commands which are also stored in the tables (such as POWER UP, DOWN messages, etc.) and data related to repetition rate timing which is used when recovering from communication errors. The total number of bytes stored in a look-up table depends on the number of commands decoded and, for example, when decoding three commands, a look-up table storing protocol image is 13 bytes long.

When a POWER command of an operating protocol has been identified, the process of logical address assignment is completed. The green LED turns on to signal status of the device to the user. From now on, the device will respond only to the protocol used in the above described process. Other codes that are intended for use with audio/video equipment may be intercepted by receiver U8 but will be rejected as communication errors by the device software. The 16-bit auto/reload timer/counter is used in performing all the required timing functions.

The look-up table containing data of assigned code is next transferred to the RAM of the chip and will be valid as long as the device is powered. When power is lost, the RAM data is lost and the device needs to repeat address/install procedure from the beginning. The address/install procedure takes a fraction of a second of software execution. The above also means that the device may be reinstalled with another address than the one assigned initially, i.e., to respond to a different protocol. All this needs is unplugging from mains, so that a new power up event leaves the device ready to accept a new logical address.

From this point on, the device software is ready to process commands that are pre-stored in its memory and transmitted under assigned keys of a standard remote. The software used in the address/install process is, in its major part, reused to perform the requested control functions.

FIG. 18c shows detailed flow-chart of software servicing reception of bi-phase code when receiving a message.

To describe what happens in the FIG. 18c illustrated software, it is enough to analyze a moment after logical address has been assigned and 16-bit timer/counter (Timer 0) controls are set up and relevant interrupts enabled. Beginning with a start pulse occurring on serial input line, an interrupt (ExtInt0) will occur. At the external interrupt 0 service routine, the Timer 0 is loaded with a value that will result in a time delay that is approximately equal to half bit time of an incoming data stream less some time to allow latency between interrupt and real-time point data sampling. Timer0 reload register is loaded with a value that will result in a time delay that is a close approximation of one bit time. The program then will start the timer, return to the main program and wait for the timer to time out generating an interrupt. At that point, the message start pulse should be about halfway through its nominal duration. When the first interrupt occurs, Timer0 interrupt service routine activates another routine which inputs other bits of incoming message to serial holding registers. If start pulse is erratic, reception is discontinued, message ignored and Timer0 released to reception of next message. A message whose start bit is valid is compared against stored references and interpreted accordingly. If message is erratic, it is discarded. For a valid message, resulting control action is then presented in the form of a duty factor value from a PWM output available with the chip used.

The new duty factor represents a power requirement, i.e., light output of the lighting arrangement under control. To present and use digital representation of the control action, a D/A conversion is needed. The latter will be implemented in the form of DC filtering of the PWM waveform whose frequency was set equal to 10 kHz. The DC voltage so obtained is the reference presented to U3-b comparator input and thus the resulting power control of lighting scheme is a function of microprocessor output reference.

The controller implementation presented above will perform light control in an infinite number of steps as well as may provide light adjustment in a few predefined steps.

Another application for using this kind of control and communication technique is in the area of lighting employing low voltage halogen light sources. The block diagram of FIG. 19 illustrates control of light output of what is termed a lamp with an extra-low-voltage halogen burner (6V, 12V or 24V types of less than 100W output, as opposed to mains voltage types which fall in the category of applications disclosed above).

FIG. 19 shows a method of controlling light output of discussed light sources in which all of the circuitry introduced earlier, such as that of FIG. 17, is employed to both interface to infrared communication and to produce a regulated raw DC bus which is in turn supplying input to an electronic transformer capable of dimming a low-voltage halogen lamp in the range of 15 to 100%, for example. Circuitry of FIG. 17 under control of remote transmitter varies phase angle of triac drive pulses and this in turn results in regulation of voltage level delivered to supply DC loads—in consequence, light output varies accordingly.

Electronic transformers used to energize low-voltage halogen lamps are such DC loads which can be operated by circuitry of FIG. 17. There are two types of electronic transformers of interest here, namely, an oscillating electronic transformer whose operation is based on high frequency self oscillations of the power stage to accommodate a low-voltage lamp and driven high frequency switching power stages which are capable of performing the halogen lamp operation.

An example of oscillating electronic transformer capable of delivering 75VA to a 12V halogen lamp is available from Advance Transformer Co. ballast model no. 6A1010CV (FCC ID. 740Y6A100) which is directly compatible with the circuitry of FIG. 17 in the arrangement shown in FIG. 19.

The above completes the description of a simple form of advanced lighting control which may be operated using a standard infrared remote transmitter. In general, if PWM is used as described above in FIG. 18c, the circuitry is hardware intensive and therefore relatively costly for a mass-produced consumer item whereas if the zero crossing of the ac line approach is used, more complex software is required but less hardware is needed and the software cost can be spread among the mass-produced items. Thus, instead of the PWM duty factor of FIG. 18c, use another microprocessor timer to time out control angle with respect to control and in sync with the ac line.

1. An infrared appliance controller comprising an infrared receiving circuit and an appliance power driver and characterized by a wide band AM infrared receiver, at least one microprocessor having memory means and timer means, a mains synced power driver capable of modulating ac power to supply at least one load, in combination with software programmed and control codes, means for comparing the codes against image codes stored in the memory means, means for isolating a single code corresponding to a single code in memory, means for rejecting other codes in favor of the corresponding single code, means for performing control activity by modulating the arc power in response to the corresponding single code.
